(19) United States
(12) Patent Application Publication
(10) Pub. No.: US 2009/0098789 A1
(43) Pub. Date: Apr. 16, 2009

(54) EQUIPMENT AND METHOD FOR PRODUCING OPTICAL SHEET FOR DISPLAY

(75) Inventors: Keisuke Endo, Shizuoka (JP); Shotaro Ogawa, Shizuoka (JP)

Correspondence Address: BIRCH STEWART KOLASCH & BIRCH, PO BOX 747, FALLS CHURCH, VA, 22040-0747, US

(73) Assignee: FUJIFILM CORPORATION, TOKYO (JP)

(21) Appl. No.: 12/066,481

(22) PCT Filed: Sep. 8, 2006
(86) PCT No.: PCT/JP2006/318317

§ 371 Date: May 17, 2008

(30) Foreign Application Priority Data
Sep. 12, 2005 (JP) 2005-264456
Sep. 12, 2005 (JP) 2005-264457

(51) Int. Cl. H01J 9/00

(52) U.S. Cl. 445/24; 29/729; 29/738; 445/66

(57) ABSTRACT

A desired optical sheet for a display is easily provided while flexibly responding to addition of size and change in size of an optical sheet for a display. An equipment for producing an optical sheet for a display, including: a joining device which joins two or more optical sheets at one or more parts, a cutting device which cuts the optical sheets joined by the joining device or periphery of optical sheets not joined by the joining device into a product size, a packaging device which stacks and packages the optical sheets joined by the joining device and a control device which variably sets the product size and the order of the joining step by the joining device, the cutting step by the cutting device and the packaging step by the packaging device.

### TECHNICAL FIELD

The present invention relates to an equipment and a method for producing an optical sheet for a display, particularly to an equipment and a method for producing all optical sheet for a display which facilitate assembling of electronic displays such as liquid crystal display devices and organic light emitting diodes or parts thereof.

### BACKGROUND ART

Recently, optical films (or optical sheets) including light diffusion films such as light guide plates which diffuse light from a light source and lens films which focus light in the front direction have been used for electronic displays such as liquid crystal display devices and organic light emitting diodes.

For example, backlight systems which illuminate a liquid crystal layer from the backside to emit light are widely used in color liquid crystal display devices employed in electronic appliances such as portable laptop computers, cell phones and liquid crystal display TVs whose number is rapidly increasing. In such backlight systems, a backlight unit is provided under the liquid crystal layer. The backlight unit generally has alight source such as a cold-cathode tube or an LED, a light guide plate and a plurality of optical sheets.

Japanese Patent Laid-Open No. 2004-184575 discloses a material in which a reflective polarizing sheet, a retardation sheet and a semi-transmissive, semi-reflective layer are stacked in an optional order with an absorption type polarizing sheet being further stacked outside the three layers. The publication describes that as many as five sheets are present between a light source device and a liquid crystal cell, and such configuration improves screen luminance and reduces power consumption.

Japanese Patent Laid-Open No. 5-51021 discloses equipment in which a plurality of cutting/stacking devices are disposed at the upstream of a packaging device and stacks obtained in the cutting/stacking devices are transferred by a conveyer to be combined at the packaging device.

Japanese Patent Laid-Open No. 7-230001, Japanese Patent No. 3123006 and Japanese Patent Laid-Open No. 5-341132 disclose a film in which function of a light diffusion film and function of a lens film are integrated.

However, such backlight units of liquid crystal display devices are designed in own size (dimension, shape) corresponding to liquid crystal screens, and so if the type of backlight units is different, the size of optical sheets is different even though, for example, the screen size of liquid crystal TVs is the same.

In such a case, it is generally very complicated and takes much time for liquid crystal manufacturers and backlight unit manufacturers to cut and join optical sheets into a desired size for every type of backlight units, and this has resulted in decreased productivity of liquid crystal display devices and backlight units.

On the other hand, when optical sheet suppliers are responsible for cutting and joining optical sheets into a desired size, it takes much time to respond to every modification of size and shape of optical sheets when providing optical sheets to many liquid crystal display manufacturers and backlight unit manufacturers. Thus, this involves a problem of decreased productivity of optical sheets.

The equipment described in Japanese Patent Laid-Open No. 5-51021 is fixed so as to combine stacks from a plurality of cutting/stacking devices at a packaging device. Since the production capacity is limited with the throughput of the packaging device being a minimum unit, extra space and extra investment burden become necessary when there is a gap between the throughput of the packaging device and the required production capacity, when production capacity is to be modified or when the size and the type of products are changed.

The above conventional configurations have another problem described below. Since stacking layers of films requires many steps, not only the steps are complicated but also the cost inevitably increases.

In addition, since the surface of flat lenses such as lenticular lenses and prism sheets are fragile and easily stained, they are generally delivered with a protective sheet being stacked on the surface.

However, such a protective sheet is merely discarded after it is removed from flat lenses, and the sheet undesirably not only wastes resources but also causes increase in the cost. In addition, operation of removing protective sheets from flat lenses is required, which then decreases productivity. Moreover, contaminants such as dust are easily attached to flat lenses upon removal of protective sheets from flat lenses due to electrostatic charge, causing problems of quality.

In addition, when stacking layers of films (sheets), scratches are easily generated due to friction upon stacking, friction from thermal expansion and thermal contraction and friction in handling.

Further, upon punching of a light diffusion sheet and a flat lens (prism sheet) which have been stacked, problems arise that the section becomes rough and a large amount of chips is produced.

The present invention has been made in order to solve the above-described problems and aims at providing equipment and a method for producing an optical sheet for a display which respond flexibly to addition or change in size of optical sheets for a display and can easily provide desired optical sheets for a display, and a method for producing an optical sheet for a display capable of punching an optical sheet into a high quality optical sheet for a display, while preventing generation of chips from cutting or cracking upon punching of a stacked sheet and reducing defects due to scratches or attachment of contaminants.

### DISCLOSURE OF THE INVENTION

To achieve the aforementioned object, the invention described in a first aspect provides equipment for producing an optical sheet for a display, comprising: a joining device which joins two or more optical sheets at one or more parts, a cutting device which cuts the optical sheets joined by the joining device or periphery of optical sheets not joined by the joining device into a product size, a packaging device which stacks and packages the optical sheets joined by the joining device and a control device which variably sets the product size and the order of the joining step by the joining device, the cutting step by the cutting device and the packaging step by the packaging device.

In this invention, since the product size and the order of the joining step by the joining device, the cutting step by the cutting device and the packaging step by the packaging device are variably set, desired optical sheets for a display can be easily provided while responding flexibly to addition or change in size of optical sheets for a display, whereas responding to sudden change in design of optical sheets for a display was conventionally difficult despite automation of equipment for producing an optical sheet for a display.

Optical sheets generally refer to various sheets having optical function and include light diffusion sheets, lens sheets (including lenticular lenses, fly-eye lenses and prism sheets), hologram sheets, polarizing sheets, anti-reflection sheets, reflection sheets, semi-reflective semi-transmissive sheets, grating sheets, interference filter sheets, color filter sheets and wavelength conversion sheets.

The invention described in a second aspect provides the equipment for producing an optical sheet for a display according to the invention described in the first aspect, further comprising a carrying device which draws the optical sheets joined by the joining device from the joining device and carries the optical sheet to the cutting device or the packaging device in accordance with an instruction from the control device, or draws the optical sheet cut by the cutting device from the cutting device and carries the optical sheet to the joining device or the packaging device in accordance with an instruction from the control device, wherein the control device notifies the carrying device of a carrying destination, thereby variably setting the order of the joining step, the cutting step and the packaging step.

The invention described in a third aspect provides the equipment for producing an optical sheet for a display according to the invention described in the first or second aspect, wherein the joining device, the cutting device and the packaging device are unconnected.

When the joining device, the cutting device and the packaging device are directly connected, determination of the balance of the capacity is difficult. However, since the joining device, the cutting device and the packaging device are unconnected, it becomes possible to respond flexibly to the required supply amount of optical sheets.

The invention described in a fourth aspect provides the equipment for producing an optical sheet for a display according to any one of the first to the third aspects, wherein the joining device and the cutting device are integrated, enabling the joining step and the cutting step to be substantially simultaneously performed.

The invention described in a fifth aspect provides the equipment for producing an optical sheet for a display according to any one of the first to fourth aspects, wherein the joining device performs at least one joining of a first joining for joining a light diffusion sheet and a lens sheet, a second joining for joining a light diffusion sheet, a first lens sheet and a second lens sheet, a third joining for joining a first light diffusion sheet, a lens sheet and a second light diffusion sheet and a fourth joining for joining a first light diffusion sheet, a first lens sheet, a second lens sheet and a second light diffusion sheet in accordance with an instruction from the control device.

The invention described in a sixth aspect provides a method for producing an optical sheet for a display, which comprises: a joining step of joining two or more optical sheets at one of more parts, a cutting step of cutting the optical sheets joined in the joining step or periphery of optical sheets not joined in the joining step into a product size, and a packaging step comprising stacking and packaging the optical sheets joined in the joining step, wherein the product size and the order of the joining step, the cutting step and the packaging step are variably set.

The invention described in a seventh aspect provides the method for producing an optical sheet for a display according to the sixth aspect, which is performed in the order of the joining step comprising stacking a first optical sheet and a second optical sheet and joining them at one or more parts, the cutting step of cutting periphery of a laminate of the optical sheets obtained by joining in the joining step into a product size and the packaging step comprising stacking and packaging the laminate of optical sheets.

The invention described in an eighth aspect provides the method for producing an optical sheet for a display according to the sixth aspect, which is performed in the order of a first cutting step of cutting periphery of a first optical sheet into a first product size and cutting periphery of a second optical sheet into the first product size, the joining step comprising stacking the first optical sheet and the second optical sheet cut in the cutting step and joining them at one or more parts, a second cutting step of cutting periphery of a laminate of the optical sheets obtained by joining in the joining step into a second product size smaller than the first product size and the packaging step comprising stacking and packaging the laminate of optical sheets.

The invention described in a ninth aspect provides the method for producing an optical sheet for a display according to the sixth aspect, which is performed in the order of the joining step and the cutting step comprising stacking a first optical sheet and a second optical sheet and joining them at one or more parts, and substantially simultaneously therewith, cutting periphery of a laminate of the first optical sheet and the second optical sheet into a product size, and the packaging step comprising stacking and packaging the laminate of optical sheets.

The invention described in a tenth aspect provides the method for producing an optical sheet for a display according to the sixth aspect, which is performed in the order of the cutting step of cutting periphery of a first optical sheet into a product size and cutting periphery of a second optical sheet into a product size, the joining step comprising stacking the first optical sheet and the second optical sheet cut in the cutting step and joining them at one of more parts and the packaging step comprising stacking and packaging a laminate of the optical sheets obtained by joining in the joining step.

The invention described in an eleventh aspect provides a method for producing an optical sheet for a display, which comprises: a stacking step of stacking at least one diffusion sheet and at least one lens sheet which have a plane size larger than a product size, thereby preparing a laminate, a punching step of punching the laminate into a product size, thereby preparing a punched body, and a joining step of joining the diffusion sheet and the lens sheet at one or more parts corresponding to periphery of the punched body, wherein a punching blade of a punching die used in the punching step has a blade tip angle of 30° to 60°, a blade thickness of 0.7 mm to 0.9 mm and a blade tip hardness of 45 Hs to 80 Hs in Shore hardness.

This makes it possible to punch a diffusion sheet and a lens sheet which have been stacked into a predetermined shape without generating chips at the section.

The present invention enables production and packaging of an optical sheet for a display of different sizes or different combining methods in a single system without significant change or replacement of an equipment or change in settings. This improves flexibility in size, combining methods and production amounts, and while flexibly responding to addition of size and change in size or package form of optical sheets for a display, cost reduction and productivity improvement can be achieved.

The present invention also makes it possible to punch a diffusion sheet and a lens sheet which have been stacked into a pre-determined shape without generating chips at the section.

### BRIEF DESCRIPTION OF THE DRAWINGS

FIG. 1 is a cross-sectional view of an embodiment of an optical sheet for a display produced by the method for producing an optical sheet for a display according to the present invention;

FIG. 2 is a cross-sectional view showing another embodiment of an optical sheet for a display;

FIG. 3 is a cross-sectional view showing still another embodiment of an optical sheet for a display;

FIG. 4 is a cross-sectional view showing still another embodiment of an optical sheet for a display;

FIG. 5 is a cross-sectional view showing still another embodiment of an optical sheet for a display;

FIG. 6 is a cross-sectional view showing still another embodiment of an optical sheet for a display;

FIG. 7 is a block diagram illustrating an example of a basic structure of an equipment for producing an optical sheet for a display;

FIG. 8 is a flowchart of an example of control processing in production of an optical sheet for a display;

FIG. 9 is a flowchart of another example of control processing in production of an optical sheet for a display;

FIG. 10 is a flowchart of another example of control processing in production of an optical sheet for a display;

FIG. 11 is a flowchart of another example of control processing in production of an optical sheet for a display;

FIG. 12 is a flowchart of another example of control processing in production of an optical sheet for a display;

FIG. 13 is a flowchart of another example of control processing in production of an optical sheet for a display;

FIG. 14 is a schematic view of production line for an optical sheet for a display applied to the first process;

FIG. 15 is a schematic view of production line for an optical sheet for a display applied to the second and the seventh processes;

FIG. 16 is a schematic view of production line for an optical sheet for a display applied to the third process;

FIG. 17 is a schematic view of production line for an optical sheet for a display applied to the fourth process;

FIG. 18 is a schematic view of production line for an optical sheet for a display applied to the fifth process;

FIG. 19 is a schematic view of production line for an optical sheet for a display applied to the sixth process;

FIG. 20A illustrates arrangement of sheets on a plane, which are to be punched out from a laminate in the first process;

FIG. 20B illustrates arrangement of sheets on a plane, which are to be punched out from a laminate in the first process;

FIG. 21A illustrates arrangement of sheets on a plane, which are to be punched out from a laminate in the second to seventh processes;

FIG. 21B illustrates arrangement of sheets on a plane, which are to be punched out from a laminate in the second to seventh processes;

FIG. 22A is a process chart illustrating an example of packaging processing by a packaging device;

FIG. 22B is a process chart illustrating an example of packaging processing by a packaging device;

FIG. 22C is a process chart illustrating an example of packaging processing by a packaging device;

FIG. 22D is a process chart illustrating an example of packaging processing by a packaging device;

FIG. 23 is a table showing the composition of resin solution used for preparing a prism sheet;

FIG. 24 is a schematic view of an apparatus for producing a prism sheet;

FIG. 25 is an enlarged view of a punching press device in the production line for an optical sheet for a display of FIG. 15;

FIG. 26 is an enlarged view of a punching blade of the punching press device of FIG. 25;

FIG. 27 illustrates examples of sizes of punching blades used in the test of the present Examples and evaluation of the result of punching;

FIG. 28 is a view showing a good section in the results of the present Examples; and

FIG. 29 is a view showing a poor section in the results of the present Examples.

### DESCRIPTION OF SYMBOLS

10, 20, 30, 40 . . . optical sheet for display, 12 . . . first diffusion sheet, 14 . . . first prism sheet, 16 . . . second prism sheet, 18 . . . second diffusion sheet, 201 . . . material feeding device, 202 . . . material carrying device, 203 . . . cutting device, 204 . . . joining device, 205 . . . product carrying device, 206 . . . packaging device, 207 . . . packaging material feeding device, 208 . . . packaging material carrying device, 209 . . . control device, 21 . . . production line for optical sheet for display, 42, 44, 46 . . . dispenser, 48 . . . punching press device, 150 . . . punching die, 152 . . . face plate, 154 . . . combined sheet, 156 . . . punching blade

### BEST MODE FOR CARRYING OUT THE INVENTION

In the following, embodiments of the present invention are described with reference to the attached figures. First, configurations of examples of optical sheets for a display produced by the method for producing an optical sheet for a display of the present invention (first to sixth embodiments) are described. Then, the processes for producing an optical sheet for a display (the first to seventh processes) are described.

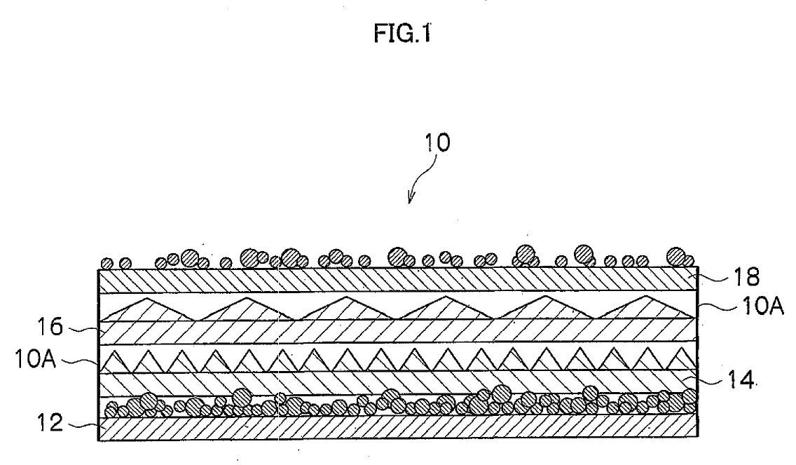

FIG. 1 is a cross-sectional view illustrating a configuration of an example of an optical sheet for a display produced by the method for producing an optical sheet for a display according to the present invention (a first embodiment).

The optical sheet for a display 10 is a module of optical sheets in which a first diffusion sheet 12, a first prism sheet 14, a second prism sheet 16 and a second diffusion sheet 18 are stacked from the bottom.

The first diffusion sheet 12 and the second diffusion sheet 18 are a sheet in which beads are fixed to the surface (one side) of a transparent film (support) by a binder and which has certain light diffusing ability. The beads on the first diffusion sheet 12 and that on the second diffusion sheet 18 have a different diameter (average particle size). Also, each sheet has different light diffusion ability.

A resin film can be used as the transparent film (support) used for the first diffusion sheet 12 and the second diffusion sheet 18. Known materials such as polyethylene, polypropylene, polyvinyl chloride, polyvinylidene chloride, polyvinyl acetate, polyester, polyolefin, acryl, polystyrene, polycarbonate, polyamide, PET (polyethylene terephthalate), biaxially oriented polyethylene terephthalate, polyethylene naphthalate, polyamideimide, polyimide, aromatic polyamide, cellulose acylate, cellulose triacetate, cellulose acetate propionate and cellulose diacetate can be used as a material of the resin film. Of these, polyester, cellulose acylate, acryl, polycarbonate and polyolefin are particularly preferably used.

The beads on the first diffusion sheet 12 and the second diffusion sheet 18 must have a diameter of 100 μm or less, preferably 25 μm or less. For example, beads may have an average particle size of 17 μm in a given distribution range of 7 to 38 μm.

The first prism sheet 14 and the second prism sheet 16 are a lens sheet in which convex lenses formed in one axial direction are disposed adjacent to each other almost on the whole sheet, for example, at a pitch of 50 μm, an irregularity height of 25 μm and an apex angle of the convex part of 90 degrees (right angle).

The first prism sheet 14 and the second prism sheet 16 are disposed so that the axis of the convex lens (prism) is substantially perpendicular to each other. Specifically, in FIG. 1, the axis of the convex lens of the first prism sheet 14 is disposed in the direction perpendicular to the sheet plane, while the axis of the convex lens of the second prism sheet 16 is disposed in the direction parallel to the sheet plane. In FIG. 1, to be able to see that the section of the second prism sheet 16 is convex, the section is shown in a direction different from the actual direction.

Various known aspects can be applied to the material of the first prism sheet 14 and the second prism sheet 16 and the method of producing them. For example, a method of producing a resin sheet may be used, in which a sheet-shaped resin material extruded through a die is pressed between a transfer roller (having a pattern opposite to that of a prism sheet on the surface) rotating at substantially the same rate as the extrusion rate of the resin material and a nip roller board positioned against the transfer roller and rotating at the same rate, thereby transferring irregularity patterns on the surface of the transfer roller to the resin.

Also, a method of producing a resin sheet in which a transfer plate (stamper) having a pattern opposite to that of a prism sheet on the surface and a resin plate are stack and press-molding is performed by a hot press by heat transfer may be used.

Resin materials which can be used in such methods include thermoplastic resins such as polymethyl methacrylate resins (PMMA), polycarbonate resins, polystyrene resins, MS resins, AS resins, polypropylene resins, polyethylene resins, polyethylene terephthalate resins, polyvinyl chloride resins (PVC), thermoplastic elastomers, copolymers thereof and cycloolefin polymers.

For another method, a method of producing a resin sheet in which irregularities on the surface of an embossed roller (having a pattern opposite to that of a prism sheet on the surface) are transferred to a transparent film which is similar to those used for the first diffusion sheet 12 and the second diffusion sheet 18 (polyester, cellulose acylate, acryl, polycarbonate, polyolefin, etc.) may be used.

More specifically, a method of producing an embossed sheet may be used, in which a transparent film in which two or more layers of an adhesive layer and a resin layer (e.g., UV curable resin) are formed by sequentially applying an adhesive and a resin is continuously transferred, and the transparent film is put over the rotating embossed roller, thereby transferring irregularities on the surface of the embossed roller to the resin layer, and the resin layer is cured with the transparent film being put over the embossed roller (for example, by irradiating with UV). The adhesive may not be used.

The method of producing the first prism sheet 14 and the second prism sheet 16 is not limited to the above examples, and other methods may be used as long as desired irregularity patterns can be formed on the surface.

As shown in FIG. 1, a joining part 10A combines layers at the left and the right ends of the optical sheet for a display 1. The joining part 10A is formed by carbon dioxide gas laser processing or the like in the joining step.

The optical sheet for a display 10 described above is disposed, for example, between a light source device and a liquid crystal cell, and used to constitute a whole liquid crystal display device. This produces an advantage that assembling of liquid crystal display devices is very easy in addition to various advantages already described (being able to produce optical sheets for a display through steps simper than those in conventional arts at low cost with high quality).

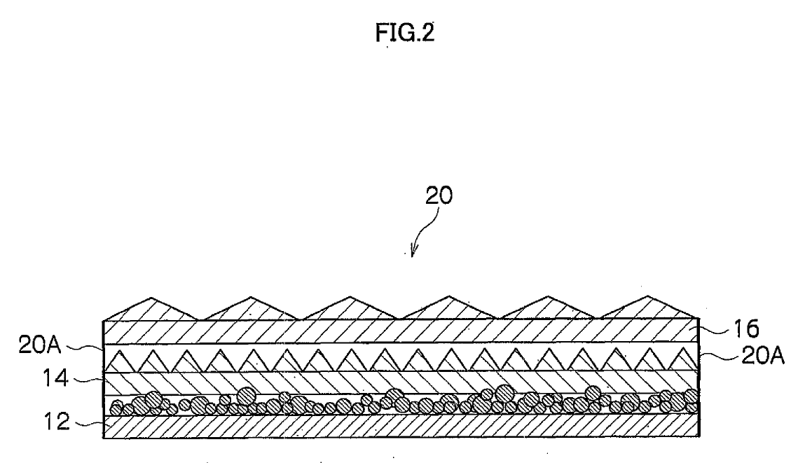

Next, another example (a second embodiment) of an optical sheet for a display produced by the method for producing an optical sheet for a display according to the present invention is described. FIG. 2 is a cross-sectional view illustrating a configuration of an optical sheet for a display 20. The same reference numerals are used for members which are the same as or similar to those in FIG. 1 (the first embodiment), and detailed description thereof is omitted.

The optical sheet for a display 20 is composed of a diffusion sheet 12, a first prism sheet 14 and a second prism sheet 16 which are stacked from the bottom. The second diffusion sheet 18 is omitted because diffusibility as wide as that in the above-described optical sheet for a display 10 is not required.

The optical sheet for a display 20 described above is disposed, for example, between a light source device and a liquid crystal cell, and used to constitute a whole liquid crystal display device as in the first embodiment.

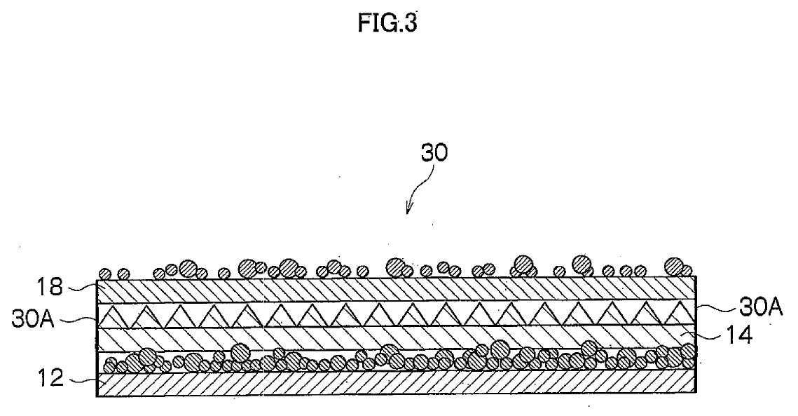

Next, still another example (a third embodiment) of an optical sheet for a display produced by the method for producing an optical sheet for a display according to the present invention is described. FIG. 3 is a cross-sectional view illustrating a configuration of an optical sheet for a display 30. The same reference numerals are used for members which are the same as or similar to those in FIG. 1 (the first embodiment) and FIG. 2 (the second embodiment), and detailed description thereof is omitted.

The optical sheet for a display 30 is composed of a first diffusion sheet 12, a prism sheet 14 and a second diffusion sheet 18 which are stacked from the bottom.

In the optical sheet for a display 30, the second prism sheet 16 is omitted because diffusibility in the direction perpendicular to the sheet plane as in the above-described optical sheet for a display 10 is not required.

The optical sheet for a display 30 described above is disposed, for example, between a light source device and a liquid crystal cell, and used to constitute a whole liquid crystal display device as in the first embodiment.

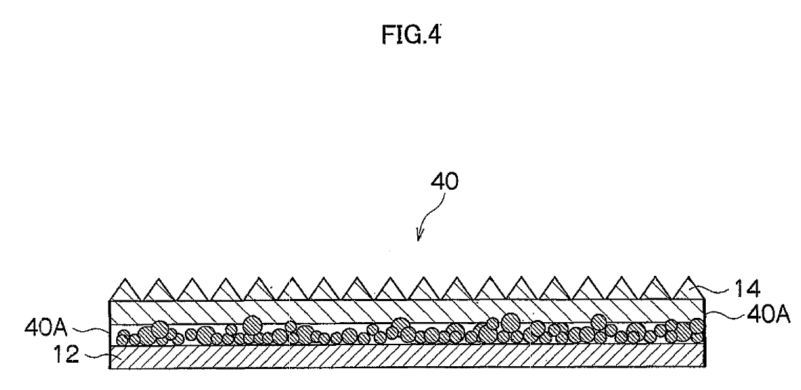

Next, still another example (a fourth embodiment) of an optical sheet for a display produced by the method for producing an optical sheet for a display according to the present invention is described. FIG. 4 is a cross-sectional view illustrating a configuration of an optical sheet for a display 40. The same reference numerals are used for members which are the same as or similar to those in FIG. 1 (the first embodiment) and FIG. 2 (the second embodiment), and detailed description thereof is omitted.

The optical sheet for a display 40 is composed of a diffusion sheet 12 and a prism sheet 14 which are stacked from the bottom. The second diffusion sheet 18 is omitted because diffusibility as wide as that in the optical sheet for a display 10 is not required. The second prism sheet 16 is omitted because diffusibility in the direction perpendicular to the sheet plane as in the optical sheet for a display 10 is not required.

The optical sheet for a display 40 described above is disposed, for example, between a light source device and a liquid crystal cell, and used to constitute a whole liquid crystal display device as in the first embodiment.

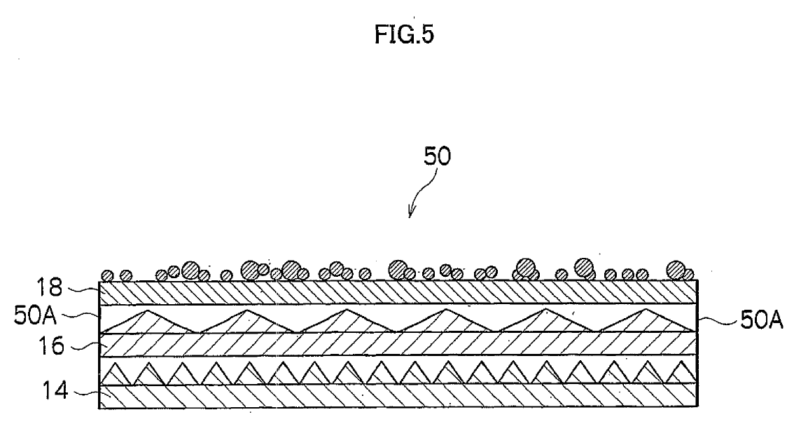

Next, still another example (a fifth embodiment) of an optical sheet for a display produced by the method for producing an optical sheet for a display according to the present invention is described. FIG. 5 is a cross-sectional view illustrating a configuration of an optical sheet for a display 50. The same reference numerals are used for members which are the same as or similar to those in FIG. 1 (the first embodiment) and FIG. 2 (the second embodiment), and detailed description thereof is omitted.

The optical sheet for a display 50 is composed of a first prism sheet 14, a second prism sheet 16 and a diffusion sheet 18 which are stacked from the bottom. The first diffusion sheet 12 is omitted because diffusibility as wide as that in the above-described optical sheet for a display 10 is not required.

The optical sheet for a display 50 described above is disposed, for example, between a light source device and a liquid crystal cell) and used to constitute a whole liquid crystal display device as in the first embodiment.

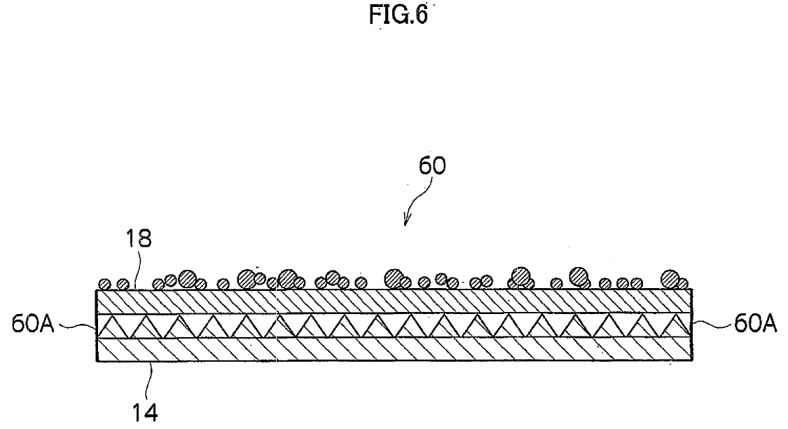

Next, still another example (a sixth embodiment) of an optical sheet for a display produced by the method for producing an optical sheet for a display according to the present invention is described. FIG. 6 is a cross-sectional view illustrating a configuration of an optical sheet for a display 60. The same reference numerals are used for members which are the same as or Similar to those in FIG. 1 (the first embodiment) and FIG. 2 (the second embodiment), and detailed description thereof is omitted.

The optical sheet for a display 60 is composed of a first prism sheet 14 and a diffusion sheet 18 which are stacked from the bottom. The first diffusion sheet 12 is omitted because diffusibility as wide as that in the above-described optical sheet for a display 10 is not required. The second prism sheet 16 is omitted because diffusibility in the direction perpendicular to the sheet plane as in the above-described optical sheet for a display 10 is not required.

The optical sheet for a display 60 described above is disposed, for example, between a light source device and a liquid crystal cell, and used to constitute a whole liquid crystal display device as in the first embodiment.

A basic structure of the equipment for producing an optical sheet for a display is now described. The equipment can be commonly applied to the above-described optical sheets for a display 10 to 60.

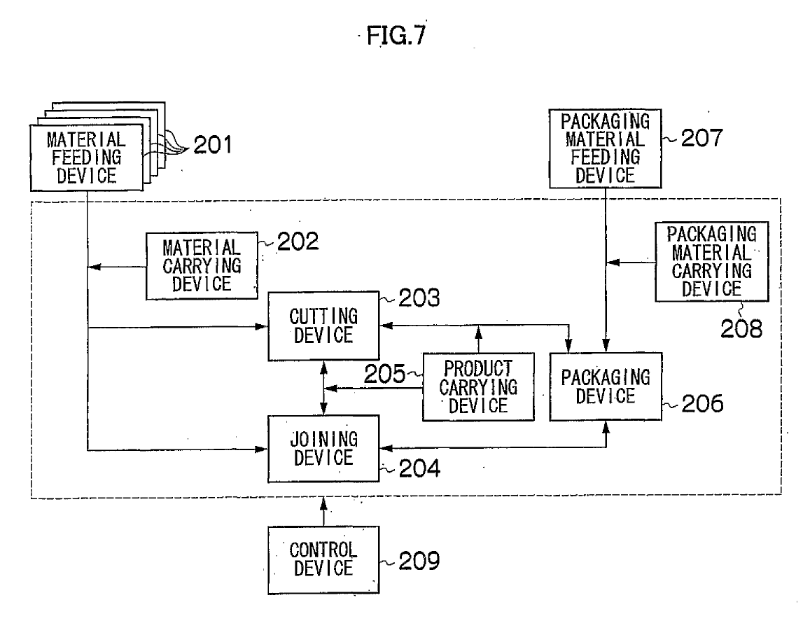

FIG. 7 is a block diagram illustrating an example of a structure of an equipment for producing an optical sheet for a display.

In this embodiment, the equipment for producing an optical sheet for a display is mainly composed of a material feeding device 201, a material carrying device 202, a cutting device 203, a joining device 204, a product carrying device 205, a packaging device 206, a packaging material feeding device 207, a packaging material carrying device 208 and a control device 209.

The material feeding device 201 feeds a single kind of optical sheet (a single optical sheet) as a material for manufacturing a combined optical sheet (a composite optical sheet). The material feeding, device 201 includes for example, a device which feeds rolled lens sheet and a device which feeds rolled light diffusion sheet.

The material carrying device 202 draws optical sheet from the material feeding device 201 and carries it to the cutting device 203 or the joining device 204 described later.

The cutting device 203 cuts periphery of optical sheet into a desired product size. The cutting herein described includes final cutting for preparing shipment products and intermediate cutting such as primary cutting for producing intermediate products before shipment. In other words, product sizes include shipment product sizes and intermediate product sizes. Specific examples of cutting include punching and cutting.

The joining device 204 joins at least one part of the periphery of two or more optical sheets to combine the sheets. Typical examples of joined optical sheet include uncut rolled composite optical sheet and sheet-shaped optical sheet that has been cut.

Although FIG. 7 shows an example in which the cutting device 203 and the joining device 204 are separate, the cutting device 203 and the joining device 204 may be integrated.

The product carrying device 205 draws an intermediate product or a shipment product of a composite optical sheet from the cutting device 203 or the joining device 204 and carries it to another device.

The packaging device 206 stacks and packages a pre-determined number of optical sheets.

The packaging material feeding device 207 feeds a packaging material for packaging a composite optical sheet.

The packaging material carrying device 208 draws a packaging material from the packaging material feeding device 207 and carries it to the packaging device 206.

Preferably, the cutting device 203, the joining device 204 and the packaging device 206 are unconnected.

The control device 209 provides instructions to and controls devices in the equipment (material carrying device 202, cutting device 203, joining device 204, product carrying device 205, packaging device 206 and packaging material carrying device 208). Instructions specifically include the size of optical sheets, the number of optical sheets, carrying destinations and packaging forms (size of packaging materials and how the sheet is packed). The control device 209 provides instructions to each device using a wired or wireless communications interface.

In particular, the control device 209 variably sets the order of the cutting step by the cutting device 203, the joining step by the joining device 204 and the packaging step by the packaging device 206, and the product size.

The control device 209 provides instructions to the material carrying device 205 to draw an optical sheet from the material feeding device 201 and carry it to either the cutting device 203 or the joining device 204. The control device 209 also provides instructions to the product carrying device 205 to draw an optical sheet which is cut in the cutting device 203 from the cutting device 203 and carry it to either the joining device 204 or the packaging device 206. The control device 209 also provides instructions to the product carrying device 205 to draw optical sheets joined in the joining device 204 from the joining device 204 and carry it to either the cutting device 203 or the packaging device 206. The control device 209 also provides instructions to the packaging material carrying device 208 to draw a packaging material from the packaging material feeding device 207 and carry it to the packaging device 206.

The control device 209 notifies the product carrying device 205 of the carrying destination and thus variably sets the order of the cutting step by the cutting device 203, the joining step by the joining device 204 and the packaging step by the packaging device 206.

The control device 209 notifies the cutting device 203 or other devices of a product size. For example, an intermediate product size or a shipment product size is notified to the cutting device 203 and the packaging device 206 from the control device 209.

The control device 209 also notifies the packaging device 206 of a packaging form. The packaging forms herein described include so-called vacuum packaging in which optical sheets are put in a given packaging bag (packaging material) and packaged by reducing pressure by suction of air, and packaging in which optical sheets are put in a dustproof cassette (packaging material) with a door which can be opened and closed and the door is closed. The instruction of packaging forms notified from the control device 209 includes the number of optical sheets to be stacked and packaged and the size of packaging materials.

When a plurality of packaging devices 206 are disposed, at least one product carrying device 205, at least one packaging material feeding device 207 and at least one packaging material carrying device 208 may be disposed between the plural packaging devices 206 or near one of the plural packaging devices 206.

The control device 209 of the equipment performs several kinds of control processing.

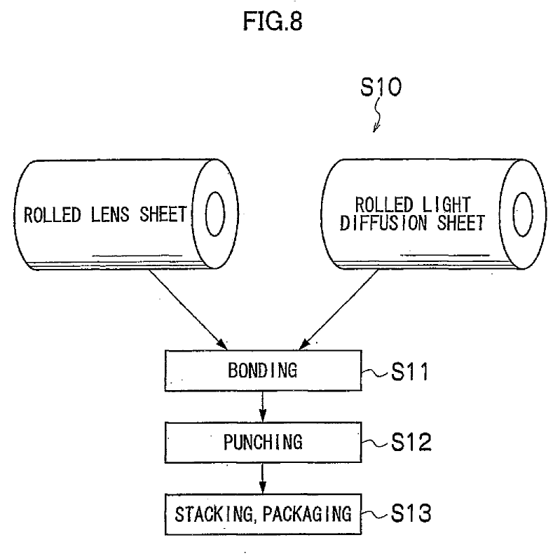

FIG. 8 illustrates first control processing in which punching (cutting step) is performed after bonding (joining step).

Referring to FIG. 8, a rolled lens sheet and a rolled light diffusion sheet are prepared (S10), and the rolled lens sheet and the rolled light diffusion sheet are transferred to the joining device 204 by the material carrying device 202 and stacked and bonded by the joining device 204 (S11). A non-rolled continuous composite optical sheet obtained by bonding is transferred to the cutting device 203 by the product carrying device 205 and punched into a shipment product size by the cutting device 203 (S12). The composite optical sheet of a shipment product size obtained by punching is transferred to the packaging device 206 by the product carrying device 205, and a packaging material is transferred to the packaging device 206 from the packaging material feeding device 207 by the packaging material carrying device 208, and a pre-determined number of the sheets are stacked and packaged in the packaging device 206 (S13).

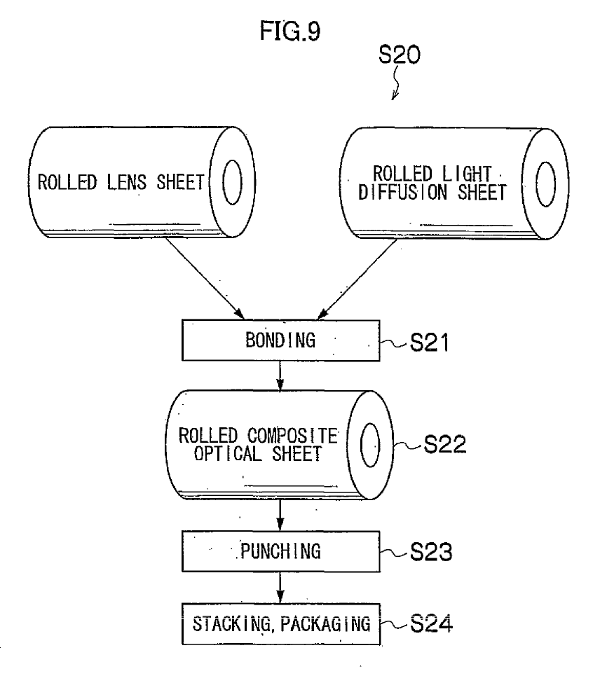

FIG. 9 illustrates second control processing in which punching (cutting step) is performed after forming a rolled composite optical sheet.

Referring to FIG. 9, a rolled lens sheet and a rolled light diffusion sheet are prepared (S20), and the rolled lens sheet and the rolled light diffusion sheet are transferred to the joining device 204 by the material carrying device 202 and bonded by the joining device 204 (S21). The resulting continuous composite optical sheet is once taken up to form a roiled composite optical sheet (S22). Subsequently, the rolled composite optical sheet is transferred to the cutting device 203 by the product carrying device 205 and punched into a shipment product size by the cutting device 203 according to shipment requirement (S23). The resulting composite optical sheet of a shipment product size is transferred to the packaging device 206 by the product carrying device 205, and a pre-determined number of the sheets are stacked and packaged in the packaging device 206 (S24).

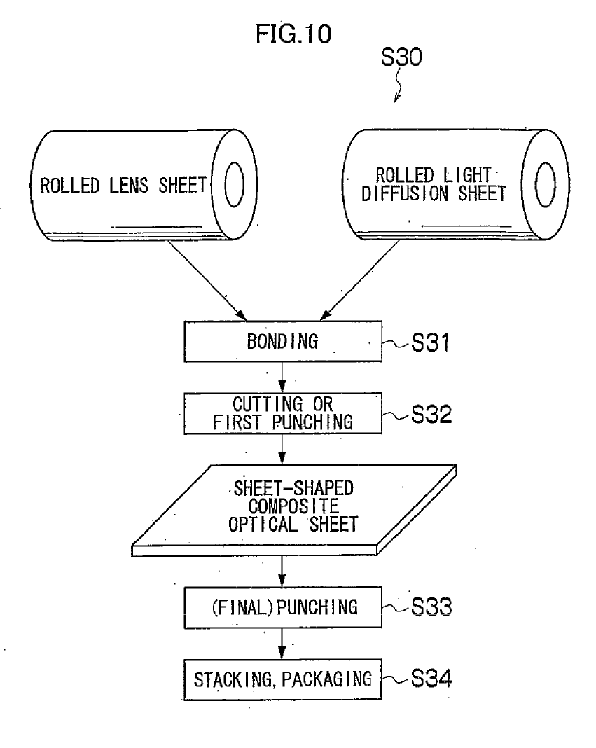

FIG. 10 illustrates third control processing in which a sheet-shaped composite optical sheet is once formed by first punching (cutting step) and then final punching (cutting step) for shipment is performed.

Referring to FIG. 10, a rolled lens sheet and a rolled light diffusion sheet are prepared (S30), and the rolled lens sheet and the rolled light diffusion sheet are transferred to the joining device 204 by the material carrying device 202 and stacked and bonded by the joining device 204 (S31). The non-rolled continuous composite optical sheet obtained by bonding is transferred to the cutting device 203 by the product carrying device 205 and punched into a pre-determined intermediate product size by the cutting device 203 (S32). The sheet-shaped composite sheet obtained by the first punching is temporarily stored. Subsequently, the sheet-shaped composite optical sheet is transferred to the cutting device 203 by the product carrying device 205 and punched into a shipment product size by the cutting device 203 according to shipment requirement (S33). The composite optical sheet of a shipment product size obtained by the final punching is transferred to the packaging device 206 by the product carrying device 205, and a pre-determined number of the sheets are stacked and packaged in the packaging device 206 (S34).

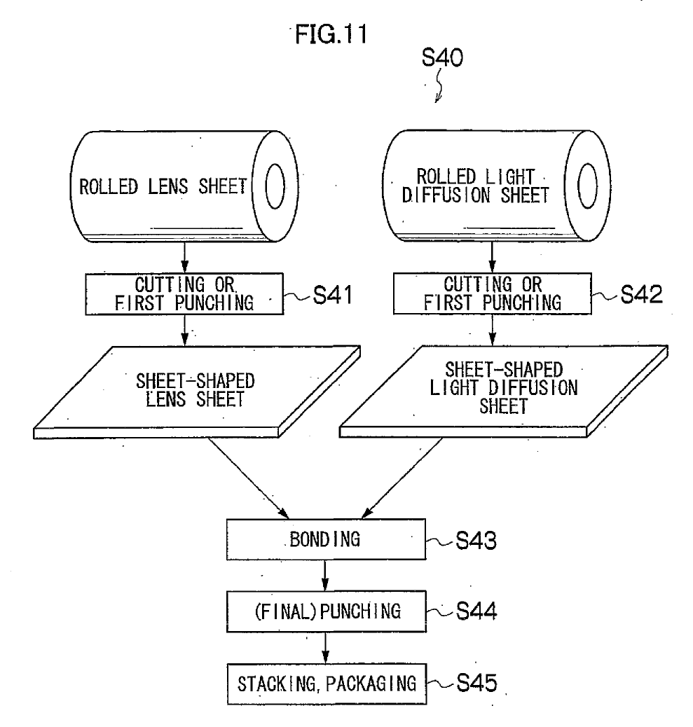

FIG. 11 illustrates forth control processing in which bonding and punching are performed after processing each rolled single optical sheet into a sheet.

Referring to FIG. 11, a rolled lens sheet and a rolled light diffusion sheet are prepared (840). The rolled lens sheet is transferred to the cutting device 203 by the material carrying device 202 and subjected to cutting or first punching to form a sheet-shaped lens sheet (S41). On the other hand, the rolled light diffusion sheet is transferred to the cutting device 203 by the material carrying device 202 and subjected to cutting or first punching to form a sheet-shaped light diffusion sheet (S42). Subsequently, the sheet-shaped lens sheet and the sheet-shaped light diffusion sheet are transferred to the joining device 204 by the product carrying device 205 and bonded by the joining device 204 (S43), then transferred to the cutting device 203 by the product carrying device 205 and punched by the cutting device 203 (S44). The punched sheet is transferred to the packaging device 206 by the product carrying device 205 and a pre-determined number of the sheets are stacked and packaged in the packaging device 206 (S45).

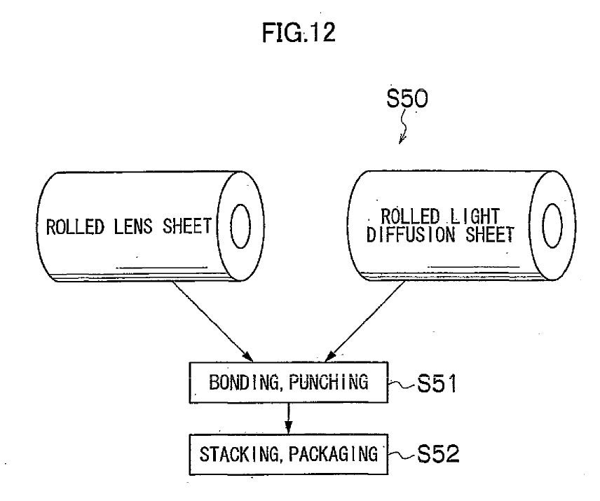

FIG. 12 illustrates fifth control processing in which bonding (joining step) and punching (cutting step) are simultaneously performed.

In this embodiment, the joining device 204 and the cutting device 203 are integrally formed. A rolled lens sheet and a rolled light diffusion sheet are prepared (S50), and the rolled lens sheet and the rolled light diffusion sheet are bonded and punched into a shipment product size almost simultaneously (S51). The composite optical sheet of a shipment product size obtained by bonding and punching is transferred to the packaging device 206 and a pre-determined number of the sheets are stacked and packaged (S52).

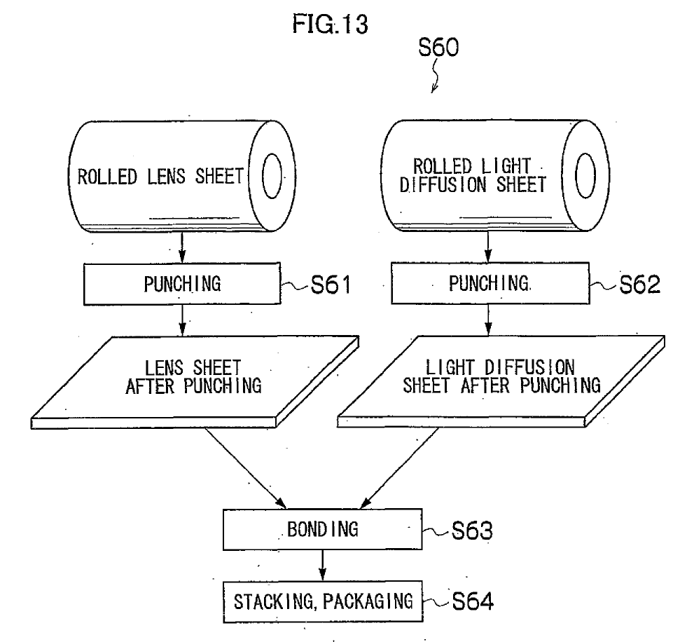

FIG. 13 illustrates sixth control processing in which bonding is performed after punching into a final shape.

Referring to FIG. 13, a rolled tens sheet and a rolled light diffusion sheet are prepared (S60), and the rolled lens sheet is transferred to the cutting device 203 by the material carrying device 202 and subjected to cutting or first punching to form a sheet-shaped lens sheet (S61). On the other hand, the rolled light diffusion sheet is transferred to the cutting device 203 by the material carrying device 202 and subjected to cutting or first punching to form a sheet-shaped light diffusion sheet of a shipment size (S62). Subsequently, the lens sheet punched into a shipment size and the sheet-shaped light diffusion sheet punched into a shipment size are transferred to the joining device 204 by the product carrying device 205 and bonded by the joining device 204 (S63). The bonded sheet is then transferred to the packaging device 206 by the product carrying device 205 and a predetermined number of the sheets are stacked and packaged in the packaging device 206 (S64).

Although only one rolled lens sheet and only one rolled light diffusion sheet are shown in FIG. 8 to FIG. 13 for a brief description, a plurality of both or either optical sheet may be present.

When combining a plurality of optical sheets by joining, the light diffusion sheet and the lens sheet may have any one of the following first to sixth configurations.

(first configuration) light diffusion sheet+lens sheet

(second configuration) light diffusion sheet+first lens sheet+second lens sheet (bonded so that ridgeline directions of the first lens sheet are substantially at right angles; the ridgeline directions are preferably substantially at right angles, but the angle may be adjusted to prevent moire.)

(third configuration) first light diffusion sheet+lens sheet+second light diffusion sheet

(fourth configuration) first light diffusion sheet+first lens sheet+second lens sheet+second light diffusion sheet

(fifth configuration) lens sheet+light diffusion sheet

(sixth configuration) first lens sheet+second lens sheet+light diffusion sheet

The processes for producing an optical sheet for a display (first to seventh processes) are now described in detail. These processes can be commonly applied to the optical sheets for a display 10 to 60 described earlier, but for illustrative purposes, a process applied to production of an optical sheet for a display of a four-layer structure (the first embodiment) is described.

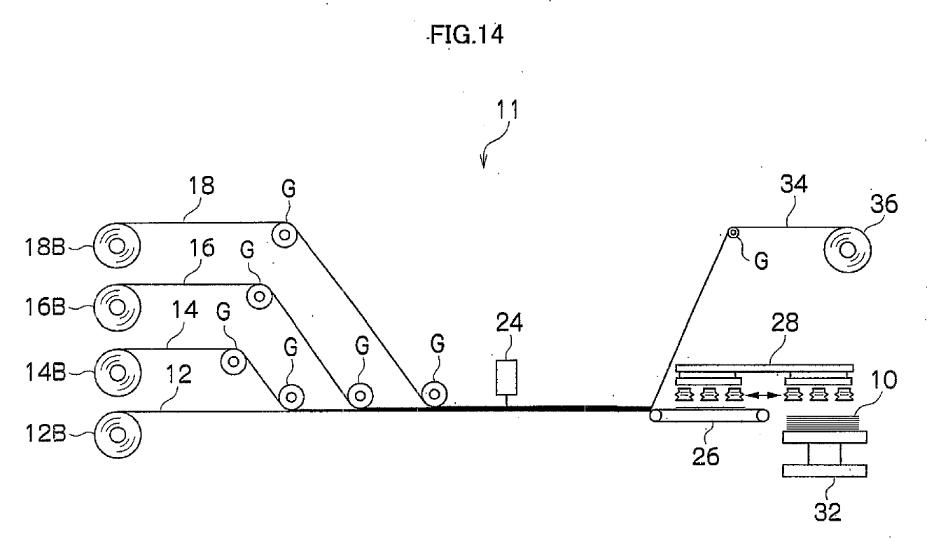

FIG. 14 is a schematic view of production line 11 for an optical sheet for a display applied to the first process. The first diffusion sheet 12, the first prism sheet 14, the second prism sheet 16 and the second diffusion sheet 18 shown in FIG. 1 described earlier are each wound around rolls 12B, 14B, 16B and 18B disposed at the left end of the figure.

The rolls 12B, 14B, 16B and 18B are each held by the rotational axis of a feeding device which is not shown. The first diffusion sheet 12, the first prism sheet 14, the second prism sheet 16 and the second diffusion sheet 18 can be fed from the rolls 12B, 14B, 16B and 18B at about the same rate.

The first diffusion sheet 12, the first prism sheet 14, the second prism sheet 16 and the second diffusion sheet 18 that have been fed are each held by guide rollers G,G and finally stacked at the upstream of the laser head 24 described below (step of stacking).

YAG laser irradiation apparatuses and semiconductor laser irradiation apparatuses with a wavelength of 355 to 1064 nm and carbon dioxide gas laser irradiation apparatuses with a wavelength of 9 to 11 μm can be used as a laser irradiation apparatus including the laser head 24. The mode of oscillation may be continuous oscillation or pulse oscillation, but when welding is almost simultaneously performed with cutting, spotting by pulse oscillation is preferred because appearance upon finish is good.

The output and the frequency required for performing cutting (cutting step) and welding (joining step) almost simultaneously vary depending on the feed rate of materials, the scanning rate of laser beams and the thickness of materials. Good welding results are obtained under conditions of an output of about 2 to 50 W and a frequency of about 100 kHz or lower.

The laser head 24 is attached to an X drive robot axis or an XY drive robot axis movable to the X direction (in the direction of the width of sheet) or the XY direction, and this makes it possible to determine positions or change tracks optionally. The entire laser head 24 may be moved depending on the irradiation pattern of laser beams, but the laser head 24 may be separately arranged (fixed) and only laser beams are guided by optical fiber to simplify the XY direction moving mechanism.

A known mechanism (aspirator, etc) which sucks in smoke generated upon cutting and welding by the laser head 24 may also be provided.

Periphery portions of a laminate which are to be cut and joined are irradiated with laser beams from the laser head 24 and with moving the irradiation spot at a constant rate, the periphery of the laminate is cut into a product size, melted and joined.

An optical sheet for a display 10 (see FIG. 1) is formed through these steps. The optical sheet for a display 10 flat has been cut and joined is transferred to a conveyor 26 and stopped. The optical sheet for a display 10 on the conveyor 26 is sequentially stacked on the packaging device 32 by a suction-type lateral transfer device 28.

A packaging material is transferred to the packaging device 32 from a packaging material feeding device which is not shown by a packaging material carrying device which is not shown, and the optical sheet for a display 10 is packaged by the packaging device 32.

On the other hand, the sheet shaped laminate 24 from which the optical sheet for a display 10 is punched out by the laser head 24 is taken up on a take-up roll 36 in a take-up device (details not shown).

The above method for producing an optical sheet for a display (the first process) provides the following advantages 1) to 3).

1) Advantage of Reducing Scratch Defect

When there are scratches on the upper surface and the lower surface of a lens sheet (a first prism sheet 14, a second prism sheet 16), they are noticeable due to lens effect. On the other hand, when scratches are present on the lower surface of a diffusion sheet (a first diffusion sheet 12, a second diffusion sheet 18), they are not noticeable because light is diffused. From these facts, prevention of scratches on the lens sheet leads to reduction of scratch defects. Scratches are often generated upon handling after processing into sheet. By combining a lens sheet and a diffusion sheet, the diffusion sheet serves as a protective sheet and therefore defects due to scratches can be reduced. This effect is particularly large in the optical sheet for a display 10 in the first embodiment (see FIG. 1) and the optical sheet for a display 30 in the second embodiment (see FIG. 3) in which the lens sheet is not exposed on the surface.

2) Advantage of Reducing the Number of Assembling Steps

When, for example, an optical sheet for a display 10 (see FIG. 1) of the first embodiment is used in assembling a liquid crystal display device, the number of assembling steps is only one, which is to incorporate the optical sheet for a display 10; but when a conventional sheet is used, assembling involves 8 steps of incorporating a first diffusion sheet [symbol] removing the protective sheet on the back side of a first lens sheet [symbol] removing the protective sheet on the surface of the first lens sheet [symbol] incorporating the first lens sheet [symbol] removing the protective sheet on the back side of a second lens sheet [symbol] removing the protective sheet on the surface of the second lens sheet [symbol] incorporating the second lens sheet [symbol] incorporating a second diffusion sheet. As described above, according to the first production process, assembling steps can be significantly reduced and thus the product cost can be reduced.

3) Advantage of Saving on Protective Sheet

A protective sheet is often put on both sides of a lens sheet for prevention of scratches. The protective sheet is discarded after the lens sheet is assembled and so is very wasteful. In the product of the present invention, the diffusion sheet serves as a protective sheet and thus helps to save on the protective sheets.

Specifically, one protective sheet can be reduced in the optical sheet for a display 40 of the forth embodiment (see FIG. 4) and the optical sheet for a display 60 of the sixth embodiment (see FIG. 6); two protective sheets can be reduced in the optical sheet for a display 30 of the third embodiment (see FIG. 3); three protective sheets can be reduced in the optical sheet for a display 20 of the second embodiment (see FIG. 2) and the optical sheet for a display 50 of the fifth embodiment (see FIG. 5); and four protective sheets can be reduced in the optical sheet for a display 10 of the first embodiment (see FIG. 1).

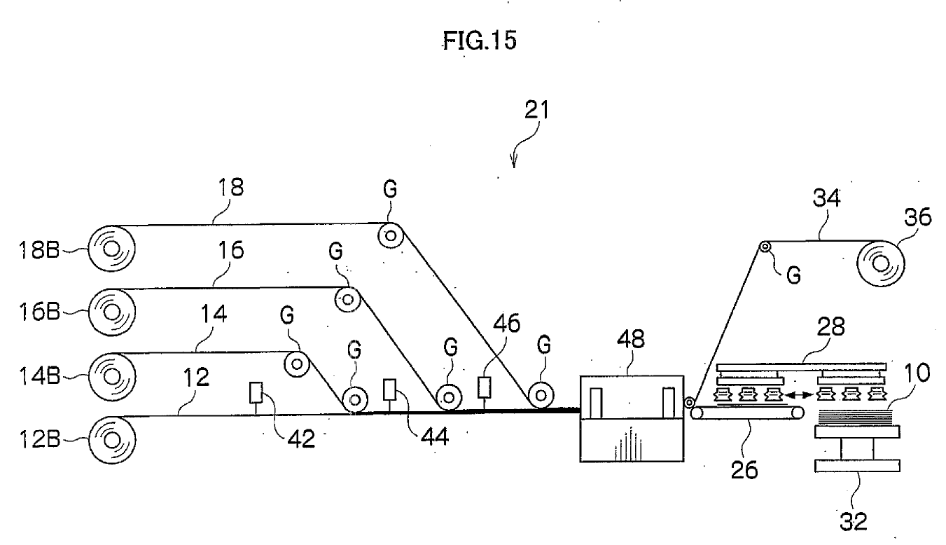

Other processes for producing an optical sheet for a display (second and seventh processes) are now described. FIG. 15 is a schematic view of production line 21 for an optical sheet for a display applied to the second and the seventh processes. The same reference numerals are used for members which are the same as or similar to those in the production line 11 for an optical sheet for a display of FIG. 14 (the first process), and detailed description thereof is omitted.

In the production line 21 for an optical sheet for a display, dispensers 42, 44, 46 and a punching press device 48 are employed instead of the laser head 24 in the production line 11 for an optical sheet for a display.

The dispensers 42, 44, 46 each are a feeder which discharges adhesive from the tip. The dispenser 42 supplies adhesive to the surface of the first diffusion sheet 12 to bond the first diffusion sheet 12 and the first prism sheet 14. The dispenser 44 supplies adhesive to the surface of the first prism sheet 14 to bond the first prism sheet 14 and the second prism sheet 16. The dispenser 46 supplies adhesive to the surface of the second prism sheet 16 to bond the second prism sheet 16 and the second diffusion sheet 18.

Preferably, the adhesive supplied from the dispensers 42, 44, 46 bonds sheets with the aid of heat or a catalyst. Specifically, general adhesives such as silicon adhesives, polyurethane adhesives, polyester adhesives, epoxy adhesives, cyanoacrylate adhesives and acrylic adhesives can be used.

Since optical sheets for a display 10 to 60 may be used at high temperatures, adhesives stable at room temperature to 120° C. are preferred. Of the above adhesives, epoxy adhesives have excellent strength and heat resistance, and therefore are preferably used. Cyanoacrylate adhesives have excellent immediate effects and strength, and therefore are applicable to efficient preparation of optical sheets for a display. Polyester adhesives are particularly preferred because they have excellent strength and processability.

These adhesives are roughly classified into thermosetting adhesives, hot melt adhesives and two component adhesives according to bonding methods. Preferably, thermosetting adhesives or hot melt adhesives which enable continuous production are used. Preferably, the adhesive is applied in a coating thickness of 0.5 μm to 50 μm regardless of which adhesive is used.

A drying device for drying adhesive is preferably provided before press rollers G (guide rollers G) at the downstream. The drying device is not particularly limited, and examples thereof include known drying methods such as drying with warm air or hot air and drying with dehumidified air.

The dispensers 42, 44, 46 are attached to an X drive robot axis or an XY drive robot axis movable to the X direction (in the direction of the width of sheet) or the XY direction, and this makes it possible to determine positions or change tracks optionally.

The dispensers 42, 44, 46 supply adhesive to the periphery portions of a laminate which are to be joined, and with transferring the laminate, the periphery of the laminate is joined by press rollers (guide rollers G) at the downstream.

A punching press device 48 at the downstream of the dispensers 42, 44, 46 cuts the periphery of the laminate into product size. In the punching press device 48, the blade pierces through the center of the bonded portion, and thus composite sheets, which are punched sheets (optical sheets for a display 10 to 60) all or some of which are bonded only at the edges, can be obtained.

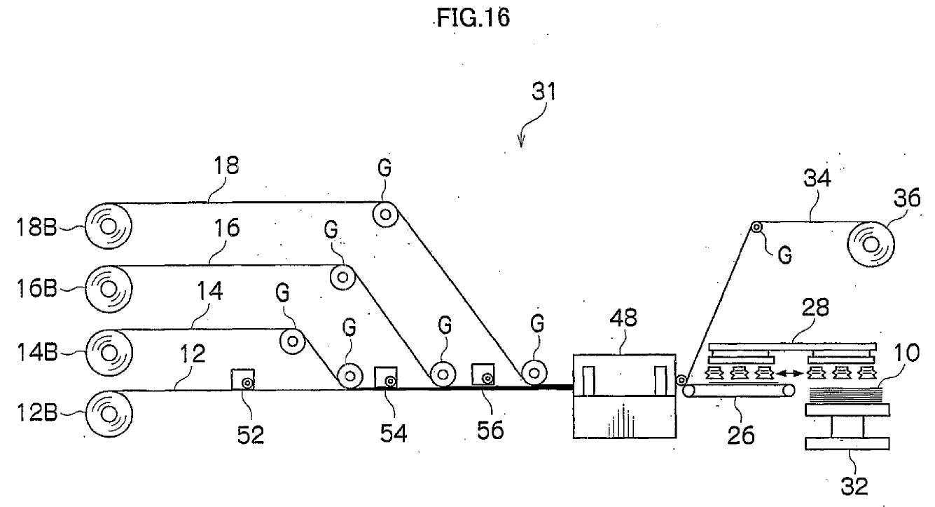

Still another method for producing an optical sheet for a display (a third process) is now described. FIG. 16 is a schematic view of production line 31 for an optical sheet for a display applied to the third process. The same reference numerals are used for members which are the same as or similar to those in the production line 11 for an optical sheet for a display of FIG. 14 (the first process) and the production line 21 for an optical sheet for a display of FIG. 15 (the second and seventh processes), and detailed description thereof is omitted.

In the production line 31 for an optical sheet for a display, tape feeders 52, 54, 56 are used instead of the dispensers 42, 44, 46 in the production line 21 for an optical sheet for a display. The tape feeders 52, 54, 56 are each a feeder which supplies double-sided adhesive tape from the tip.

The tape feeder 52 supplies double-sided adhesive tape to the surface of the first diffusion sheet 12 to adhere the first diffusion sheet 12 and the first prism sheet 14. The tape feeder 54 supplies double-sided adhesive tape to the surface of the first prism sheet 14 to adhere the first prism sheet 14 and the second prism sheet 16. The tape feeder 56 supplies double-sided adhesive tape to the surface of the second prism sheet 16 to adhere the second prism sheet 16 and the second diffusion sheet 18.

The double-sided adhesive tape supplied from the tape feeders 52, 54, 56 have adhesive applied to both faces. Highly adhesive acrylic copolymer resin can be used as the adhesive for the double-sided adhesive tape. In addition to this, for example, silicon, natural rubber or synthetic rubber adhesive may be used. In consideration of all of heat resistance, physical strength such as creep resistance and costs, acrylic adhesives are preferably used.

For the tape feeders 52, 54, 56 which supply double-sided adhesive tape, commercially available general tape dispensers may be used. The tape feeders 52, 54, 56 are attached to a uniaxial moving mechanism which is movable to any position in the X direction (direction of the width of the sheet), and the position where double-sided adhesive tape is applied can be changed according to punching patterns.

A pivot mechanism is disposed at the part where the tape feeders 52, 54, 56 are fixed. The mechanism is capable of dealing with taping patterns in diagonal directions as well by changing the position of the tape feeders 52, 54, 56 corresponding to the feeding rate of the sheet.

In the punching press device 48 at the downstream of the tape feeders 52, 54, 56, the blade pierces through the center of the width of the bonded tape, and thus composite sheets, which are punched sheets (optical sheets for a display 10 to 60) all or some of which are bonded only at the edges, can be obtained.

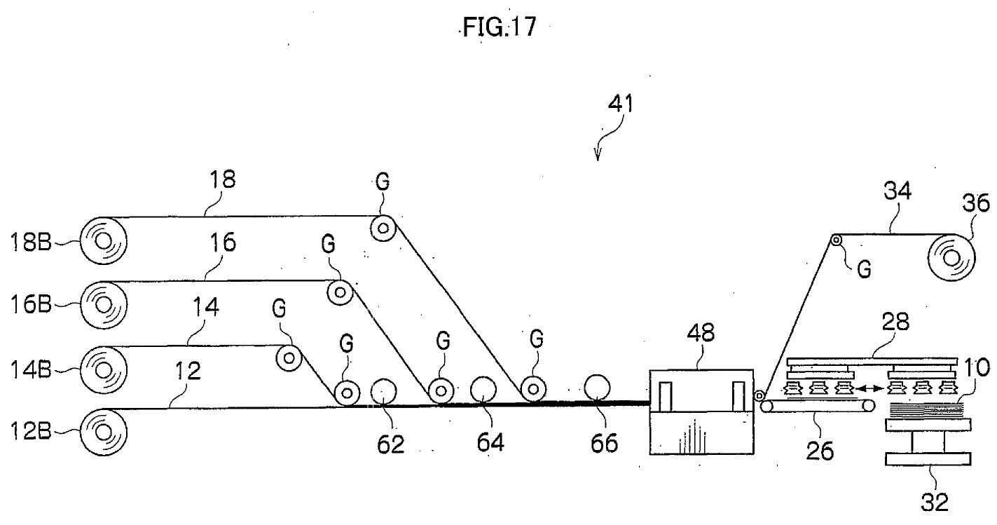

Still another method for producing an optical sheet for a display (a fourth process) is now described. FIG. 17 is a schematic view of production line 41 for an optical sheet for a display applied to the fourth process. The same reference numerals are used for members which are the same as or similar to those in the production line 11 for an optical sheet for a display of FIG. 14 (the first process), the production line 21 for an optical sheet for a display of FIG. 15 (the second and seventh processes) and the production line 31 for an optical sheet for a display of FIG. 16 (third process), and detailed description thereof is omitted.

In the production line 41 for an optical sheet for a display, ultrasonic horns 62, 64, 66 are used instead of the dispensers 42, 44, 46 in the production line 21 for an optical sheet for a display. The ultrasonic horns 62, 64, 66 are each provided at the downstream of press rollers (guide rollers G).

The ultrasonic horns 62, 64, 66 are a device which fusion bonds two or more stacked sheets. Specifically, ultrasonic horn 62 fuses the first diffusion sheet 12 and the first prism sheet 14. The ultrasonic horn 64 fusion bonds the first prism sheet 14 and the second prism sheet 16. The ultrasonic horn 66 fusion bonds the second prism sheet 16 and the second diffusion sheet 18.

Ultrasonic horns which are moved up and down with an air cylinder or ultrasonic horns which are moved up and down by a servomotor are conventionally known as ultrasonic horns 62, 64, 66 (ultrasonic fusion device). However, any type of ultrasonic fusion device may be employed as long as sheets can be fused by applying ultrasonic vibration with applying load to the sheets.

For controlling the position of ultrasonic horns 62, 64, 66, positions are changed only in the width direction of the sheet when the punching pattern is parallel to the feed direction of the sheet. However, to respond to punching patterns in diagonal directions, an oscillating mechanism which can change the moving direction of the ultrasonic horns 62, 64, 66 to any direction is provided, and the ultrasonic horns 62, 64, 66 are moved in the width direction corresponding to the moving distance of the sheet.

Setting conditions of the ultrasonic horns 62, 64, 66 are determined so that the portion to be fusion bonded is not melted down by heat. The portion to be bonded may be cooled after bonding (fusing) using an air cooling mechanism such as air blowing according to need.

In the punching press device 48 at the downstream of ultrasonic horns 62, 64, 66, the blade pierces through the center of the bonded fused portion, and thus composite sheets, which are punched sheets (optical sheets for a display 10 to 60) all or some of which are bonded only at the edges, can be obtained.

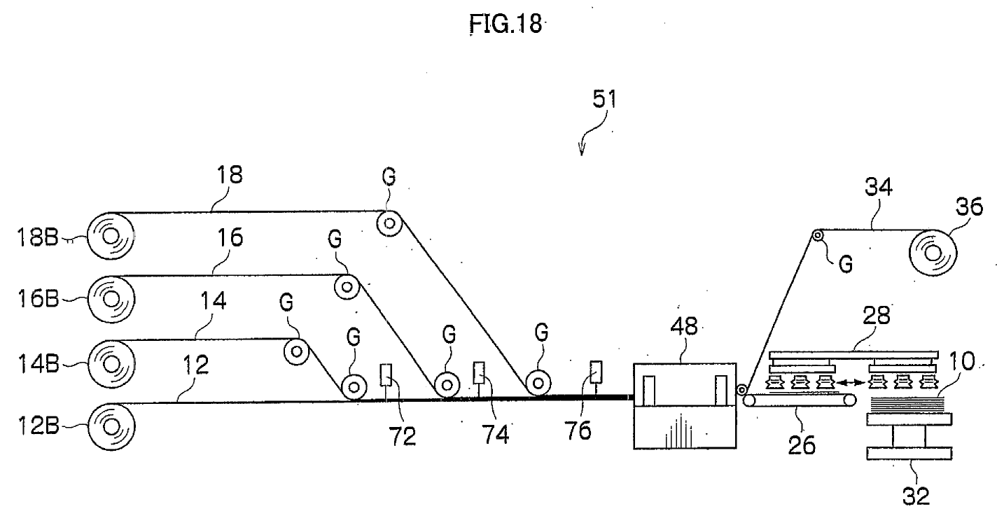

Still another method for producing an optical sheet for a display (a fifth process) is now described. FIG. 18 is a schematic view of production line 51 for an optical sheet for a display applied to the fifth process. The same reference numerals are used for members which are the same as or similar to those in the production line 11 for an optical sheet for a display of FIG. 14 (the first process), the production line 21 for art optical sheet for a display of FIG. 15 (the second and seventh processes) and the production line 31 for an optical sheet for a display of FIG. 16 (the third process), and detailed description thereof is omitted.

In the production line 51 for an optical sheet for a display, laser heads 72, 74, 76 are used instead of the ultrasonic horns 62, 64, 66 in the production line 41 for an optical sheet for a display. The laser heads 72, 74, 76 are each disposed at the downstream of press rollers (guide rollers G) as are the ultrasonic horns 62, 64, 66.

The laser heads 72, 74, 76 are a device which fusion bonds two or more stacked sheets as does the ultrasonic horns 62, 64, 66. Specifically, the laser head 72 fusion bonds the first diffusion sheet 12 and the first prism sheet 14. The laser head 74 fusion bonds the first prism sheet 14 and the second prism sheet 16. The laser head 76 fusion bonds the second prism sheet 16 and the second diffusion sheet 18.

The laser heads 72, 74, 76 are different from the laser head 24 in the production line 11 for an optical sheet for a display of FIG. 14 (the first process), and are used only for the joining step. The cutting step is performed in the punching press device 48. The basic specification and surrounding configurations of the laser heads 72, 74, 76 are substantially the same as those in the first process.

Setting conditions of the laser heads 72, 74, 76 are determined so that the portion to be fusion bonded is not melted down by heat. The portion to be bonded may be cooled after bonding (fusing) using an air cooling mechanism such as air blowing according to need.

In the punching press device 48 at the downstream of laser heads 72, 74, 76, the blade pierces through the center of the bonded fused portion, and thus composite sheets, which are punched sheets (optical sheets for a display 10 to 60) all or some of which are bonded only at the edges, can be obtained.

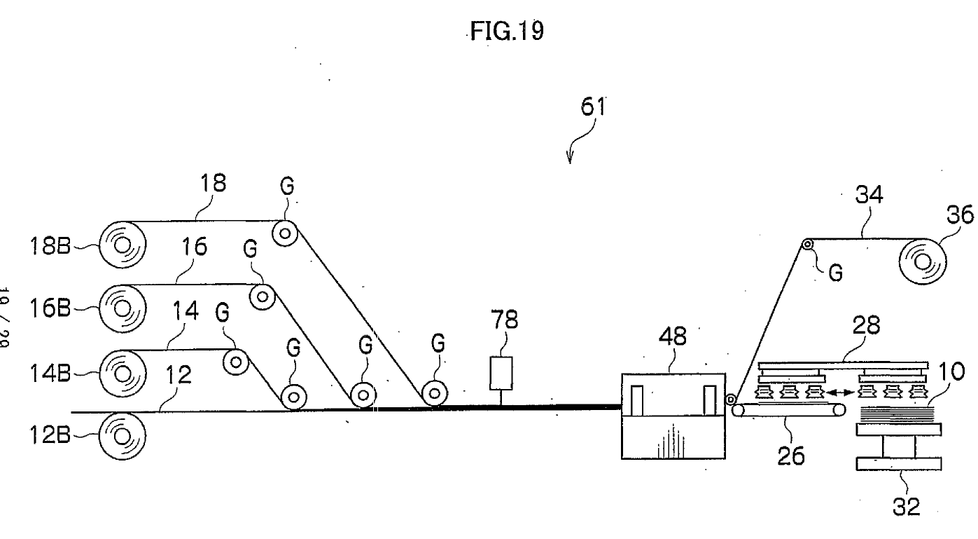

Still another method for producing an optical sheet for a display (a sixth process) is now described. FIG. 19 is a schematic view of production line 61 for an optical sheet for a display applied to the sixth process. The same reference numerals are used for members which are the same as or similar to those in the production line 11 for an optical sheet for a display of FIG. 14 (the first process), the production line 21 for an optical sheet for a display of FIG. 15 (the second and seventh processes) and the production line 31 for an optical sheet for a display of FIG. 16 (third process), and detailed description thereof is omitted.

In the production line 61 for an optical sheet for a display, a laser head 78 is used instead of the three laser heads 72, 74, 76 in the production line 51 for an optical sheet for a display. The laser head 78 is disposed at the downstream of press rollers (guide rollers G).

The laser head 78 is a device which fuses two or more stacked sheets. Specifically, the laser head 78 fusion bonds a laminate of the first diffusion sheet 12, the first prism, sheet 14, the second prism sheet 16 and the second diffusion sheet 18.

The laser head 78 is different from the laser head 24 in the production line 11 for an optical sheet for a display of FIG. 14 (the first process), and is used only for the joining step. The cutting step is performed in the punching press device 48. The basic specification and surrounding configurations of the laser head 78 are substantially the same as those in the first process.

Setting conditions of the laser head 78 are determined so that the portion to be fusion bonded is not melted down by heat. The portion to be bonded may be cooled after bonding (fusing) using an air cooling mechanism such as air blowing according to need.

In the punching press device 48 at the downstream of laser head 78, the blade pierces through the center of the bonded used portion, and thus composite sheets, which are punched sheets (optical sheets for a display 10 to 60) all or some of which are bonded only at the edges, can be obtained.

Arrangement of sheets (optical sheets for a display 10 to 60) on a plane, which are punched out from a laminate of the first diffusion sheet 12, the first prism sheet 14, the second prism sheet 16 and the second diffusion sheet 18, is now described.

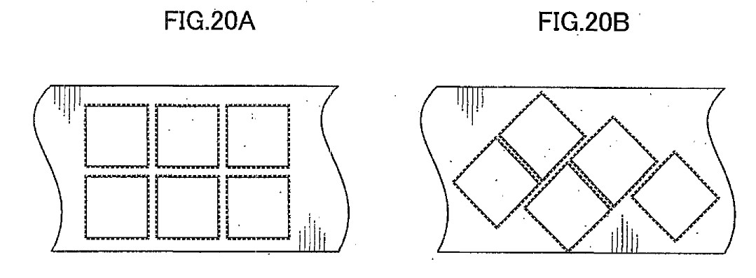

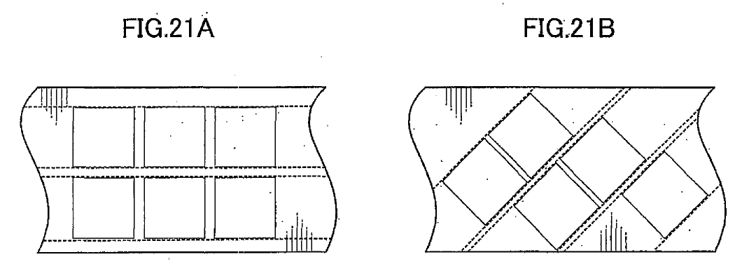

FIGS. 20A, B illustrate arrangement of sheets (optical sheets for a display 10 to 60) on a plane, which are punched out from a laminate in the first process. FIGS. 21A, B illustrate arrangement of sheets (optical sheets for a display 10 to 60) on a plane, which are punched out from a laminate in the second to sixth processes.

FIG. 20A illustrates performing fusion bonding (joining step) and punching (cutting step) parallel to the transferring direction of a laminate. FIG. 20B illustrates performing fusion bonding (joining step) and punching (cutting step) diagonal to the transferring direction of a laminate. In the figures, points on the periphery of sheets that are punched out from the laminate indicate fusion bonded portions.

FIG. 21A illustrates performing fusing or bonding (joining step) in the direction parallel and perpendicular to the transferring direction of a laminate. FIG. 21B illustrates performing fusing or bonding (joining step) in the direction diagonal to the transferring direction of a laminate. In the figures, points on the periphery of sheets that are punched out from the laminate indicate fused portions or bonded portions.

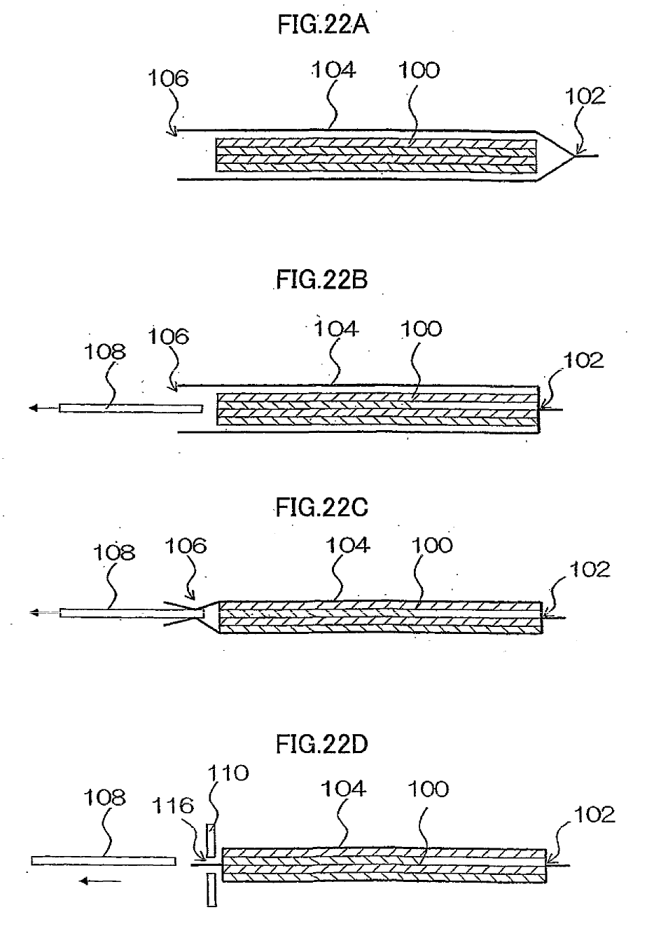

FIGS. 22A to D are process charts illustrating an example of packaging processing by a packaging device 206.

First, as shown in FIG. 22A, a pre-determined number of composite optical sheets 100 which are stacked with their ends being aligned are put into a packaging back 104 (a packaging material) one end 102 of which is previously sealed.

Then, as shown in FIG. 22B, an air suction nozzle 108 which sucks in air in the packaging bag 104 is inserted into an opening 106 of the packaging bag 104, and by operating a vacuum pump which is not shown, air in the packaging bag 104 is removed through the air suction nozzle 108. As a result, the packaging bag 104 shrinks as shown in FIG. 22C and the pressure in the packaging bag 104 is reduced.

When the packaging bag 104 is completely shrunk, the opening 106 of packaging bag 104 is heat sealed by a heat seal unit 110. The air suction nozzle 108 is retreated almost simultaneously with heat sealing.

By removing air in the packaging bag 104 as described above, the packaging bag 104 favorably comes into close contact with a bundle of optical sheets 100 to fix the optical sheets 100, avoiding problems such as collapse of load during transportation and generation of dust due to friction in the packaging bag.

As described above, the present invention makes it possible to produce a high quality optical sheet for a display at a lower cost through simpler steps compared to conventional cases.

The present invention also provides the following advantages.

1) Improvement in Product Value by Cost Reduction and Thinning

Since rigidity is required for optical sheets used for large liquid crystal TVs, supports whose thickness is about twice the thickness of conventional supports are used. However, since the optical sheet according to the present invention is a composite of sheets, the sheet has sufficient rigidity without increasing the thickness of each layer, and the thickness of each layer can be reduced.

2) Improvement in Performance by Preventing Reduction of Converging Effect

To prevent scratches on the lens sheet (make scratches less noticeable), matte treatment is performed on the backside of some products. However, the optical sheet according to the present invention does not require such treatment, and thus not only production cost can be reduced but also reduction of converging effect due to such matte treatment can be prevented, and therefore performance is improved.

Still another method for producing an optical sheet for a display (a seventh process) is now described. Rolls 12B, 14B, 16B and 18B are each held by a rotational axis of a feeding device which is not shown. The first diffusion sheet 12, the first prism sheet 14, the second prism sheet 16 and the second diffusion sheet 18 each can be fed from the rolls 12B, 14B, 16B and 18B at about the same rate.

The first diffusion sheet 12, the first prism sheet 14, the second prism sheet 16 and the second diffusion sheet 18 that have been fed are each held by guide rollers G, G . . . .

Also, as shown in FIG. 15, dispensers 42, 44, 46 and a punching press device 48 are disposed. The dispensers 42, 44, 46 each are a feeder which discharges adhesive from the tip. The dispenser 42 supplies adhesive to the surface of the first diffusion sheet 12 to bond the first diffusion sheet 12 and the first prism sheet 14. The dispenser 44 supplies adhesive to the surface of the first prism sheet 14 to bond the first prism sheet 14 and the second prism sheet 16. The dispenser 46 supplies adhesive to the surface of the second prism sheet 16 to bond the second prism sheet 16 and the second diffusion sheet 18.

Preferably, the adhesive supplied from the dispensers 42, 44, 46 bonds sheets with the aid of heat or a catalyst. Specifically, general adhesives such as silicon adhesives, polyurethane adhesives, polyester adhesives, epoxy adhesives, cyanoacrylate adhesives and acrylic adhesives can be used.

Since optical sheets for a display 10 to 60 may be used at high temperatures, adhesives stable at room temperature to 120° C. are preferred. Of the above adhesives, epoxy adhesives have excellent strength and heat resistance, and therefore are preferably used. Cyanoacrylate adhesives have excellent immediate effects and strength, and therefore are applicable to efficient preparation of optical sheets for a display. Polyester adhesives are particularly preferred because they have excellent strength and processability.

These adhesives are roughly classified into thermosetting adhesives, hot melt adhesives and two-component adhesives according to bonding methods. Preferably, thermosetting adhesives or hot melt adhesives which enable continuous production are used. Preferably, the adhesive is applied in a coating thickness of 0.5 μm to 50 μm regardless of which adhesive is used.

A drying device for drying adhesive is preferably provided before press rollers G (guide rollers G) at the downstream. The drying device is not particularly limited, and examples thereof include known drying methods such as drying with warm air or hot air and drying with dehumidified air.

The dispensers 42, 44 and 46 are attached to an X drive robot axis or an XY drive robot axis movable to the X direction (in the direction of the width of sheet) or the XY direction, and this makes it possible to determine positions or change tracks optionally.

The dispensers 42, 44, 46 supply adhesive to the periphery portions of a laminate which are to be joined, and with transferring the laminate, the periphery of the laminate is joined by press rollers (guide rollers G) at the downstream.

A punching press device 48 at the downstream of the dispensers 42, 44, 46 cuts the periphery of the laminate into product size. In the punching press device 48, the blade pierces through the center of the bonded portion, and thus composite sheets, which are punched sheets (optical sheets for a display 10) all or some of which are bonded only at the edges, can be obtained.

In the above method for producing an optical sheet for a display, adhesive is supplied using the dispensers 42, 44, 46 to join the laminate, but the method of joining the laminate is not limited thereto, and various methods can be used.

For example, while not shown, tape feeders may be used to supply double-sided adhesive tape instead of the dispensers 42, 44, 46 to join the laminate.

Alternatively, ultrasonic horns may be used instead of the dispensers 42, 44, 46 to fuse the stacked sheets. Furthermore, a laser head may be used instead of the ultrasonic horns to fuse the stacked sheets. Two stacked sheets may be fused by the laser head or four sheets shown in FIG. 15 may be fused together by the laser head.

Arrangement of sheets (optical sheets for a display 10) on a plane, which are punched out from a laminate of the first diffusion sheet 12, the first prism sheet 14, the second prism sheet 16 and the second diffusion sheet 18, is now described.

FIGS. 21A, B illustrate arrangement of sheets (optical sheets for a display 10) on a plane, which are punched out from a laminate in the process of the present embodiment.

FIG. 21A illustrates performing fusing or bonding (joining step) in the direction parallel and perpendicular to the transferring direction of a laminate. FIG. 21B illustrates performing fusing or bonding (joining step) in the direction diagonal to the transferring direction of a laminate. In the figures, points on the periphery of sheets that are punched out from the laminate indicate fused portions or bonded portions.

### EXAMPLES

Specific Examples are now described.

Here, a composite sheet (an optical sheet for a display 10) obtained by bonding, from the bottom a first diffusion sheet 12 having a thickness of 1.1 mm, a first prism sheet 14 having a thickness of 1.5 mm, a second prism sheet 16 having a thickness of 1.5 mm and a second diffusion sheet 18 having a thickness of 1.1 mm by laser fusion was used as a processing target.

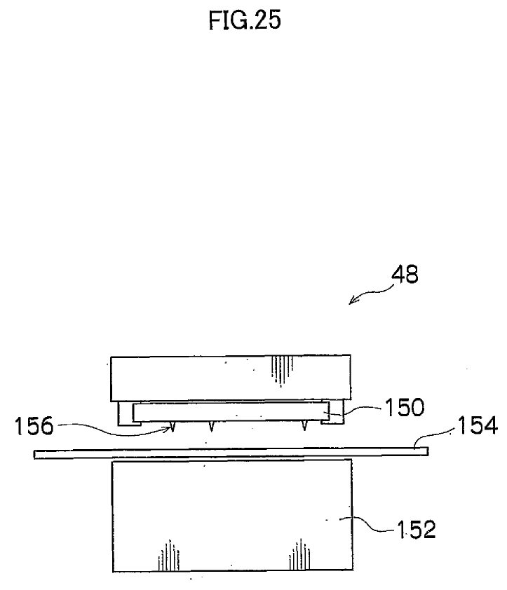

The composite sheet was punched by a punching, press device 48 as shown in FIG. 15. An enlarged view of the punching press device 48 is shown in FIG. 25. In the punching press device 48, a composite sheet 154 (an optical sheet for a display 10) transferred between a punching die 150 and a face plate 152 is punched by a punching blade 156 attached to the punching die 150 as shown in FIG. 25.

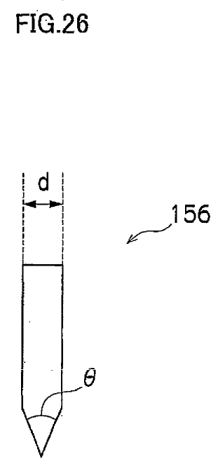

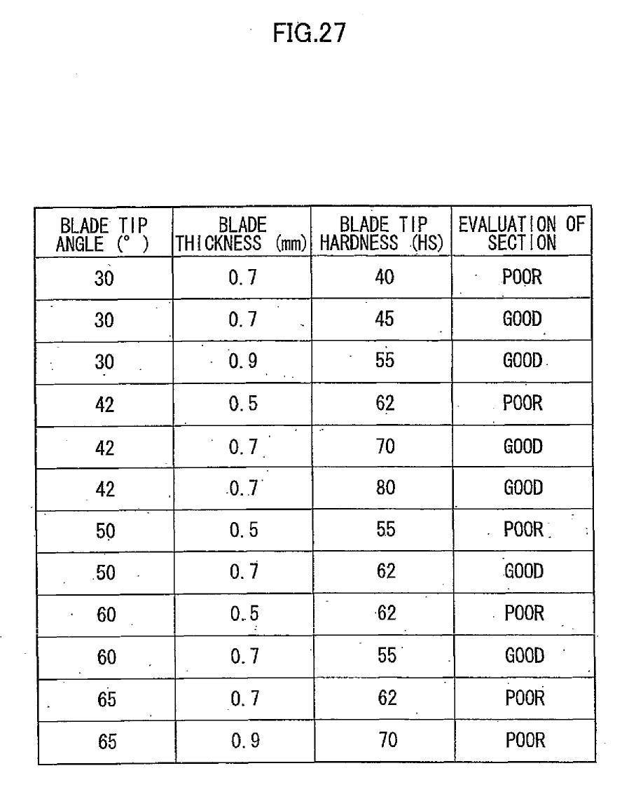

And enlarged view of the punching blade 156 is shown in FIG. 26. The punching blade 156 has a blade thickness d and a blade tip angle θ. Punching of the above punching target (the composite sheet 154) was performed using a test cutting die having a test blade of a size shown in FIG. 27 by changing the blade thickness d, the blade tip angle θ and the hardness (Shore hardness Hs) as shown in FIG. 27.

For obtaining the result of the punching processing, the section was photographed by a confocal microscope (HD100 made by Lasertec Corporation) and the condition of the section was evaluated.

For evaluation, whether chips from cutting were generated at the section was visually observed. As shown in FIG. 27, the evaluation is that results with a good section without generation of chips are marked good and results with a poor section in which chips are generated are marked poor.

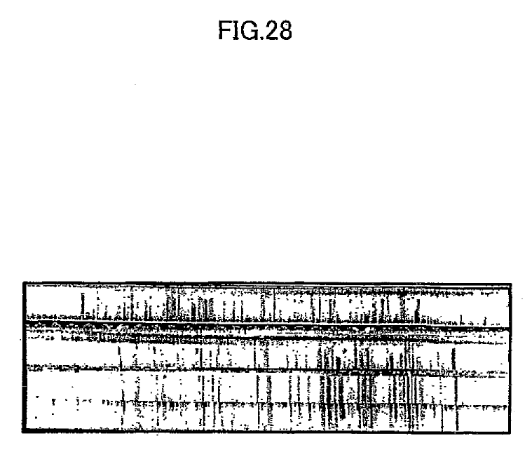

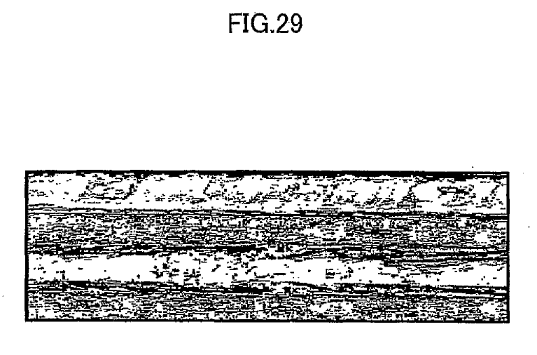

For comparison, an example of a good section without generation of chips is shown in FIG. 28 and an example of a poor section in which chips are generated is shown in FIG. 29.

As shown in FIG. 28, the section is uniform and no chip is generated in the good section. In contrast, as shown in FIG. 29, the section is rough and a large amount of chips are generated in the poor section.

The results show that a punching die with a blade tip angle θ of 30° to 60°, a blade thickness d of 0.7 mm to 0.9 mm and a blade tip hardness of 45 Hs to 80 Hs is preferred. By performing punching processing using a punching die of such a size, a diffusion sheet and a prism sheet that have been stacked can be punched into a pre-determined shape without generation of chips from cutting at the section. This eliminates the need for the use of protective films on the surface and thus contributes to reduction of material costs.

Moreover, since the number of operations of incorporating members necessary for assembling a backlight is reduced, the labor cost can be reduced. Further, since attachment of dust due to electrostatic charge generated upon removing the protective sheet can be prevented, the quality of products can be improved.

In addition, since punching is performed after bonding a prism sheet and a diffusion sheet, the time required for punching is reduced to half compared to punching each sheet separately, and thus productivity can be improved.

Embodiments of the method for producing an optical sheet for a display of the present invention have been described above, but the present invention is not limited to the above embodiments and various other aspects can also be applied.

For example, although the prism of the first prism sheet 14 and the second prism sheet 16 is always upward in the present embodiments, the sheets can be stacked with the prism downward.

The layer structure of the optical sheet for a display is not limited to those in the embodiments either, and for example, protective sheets can be stacked on the top and the bottom surfaces.

Such configurations function in the same way as in the present embodiments and produce similar effects.

### Example

### Preparation of Prism Sheet

A prism sheet used for the first prism sheet 14 and the second prism sheet 16 was prepared. The prism sheet is commonly used for the first prism sheet 14 and the second prism sheet 16.

Preparation of Resin Solution

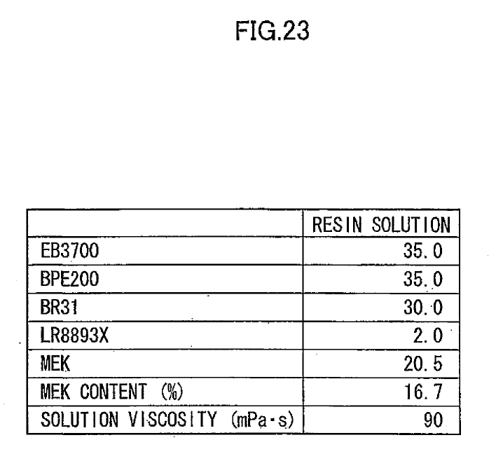

Compounds listed in the table of FIG. 23 were mixed at weight ratios shown in the table. The mixture was heated to 50° C. and the compounds were dissolved with stirring to give a resin solution. The name and the type of the compounds are as follows.

EB3700: Ebecryl 3700 available from Daicel-UCB CO., LTD., bisphenol A epoxyacrylate, (viscosity: 2200 mPa·s/65° C.)

BPE200: NK Ester BPE-200 available from SHIN-NAKAMURA CHEMICAL CO., LTD., dimethacrylate ester of ethylene oxide adduct bisphenol A (viscosity: 590 mPa·s/25° C.)

BR-31: New Frontier BR-31 available from DAI-ICHI KOGYO SEIYAKU CO., LTD., tribromophenoxyethyl acrylate (solid at room temperature, melting point 50° C. or higher)

LR8893X: Lucirin LRS893X, radical generator available from BASF, ethyl-2,4,6-trimethylbenzoyl ethoxyphenylphosphine oxide

MEK: methyl ethyl ketone

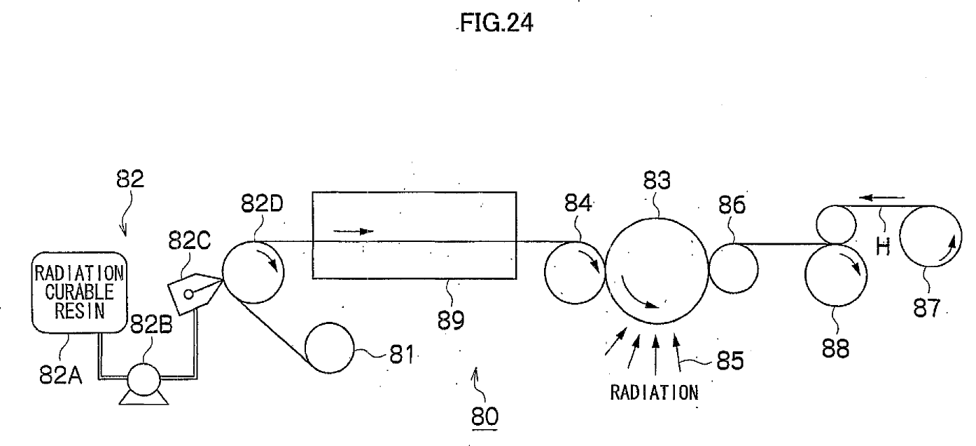

A prism sheet was produced using an apparatus for producing a prism sheet having a configuration shown in FIG. 24.

A transparent PET (polyethylene terephthalate) film having a width of 500 mm and a thickness of 100 μm was used as sheet W.

A roller having a length (in the direction of the width of the sheet W) of 700 mm and a diameter of 300 mm made of S45C whose surface is made of nickel was used as an emboss roller 83. Grooves with a pitch of 50 μm in the roller axis direction were formed on the surface of the roller in a width of about 500 mm across the entire circumference by cutting using a diamond tool (single point). The cross-section of the groove is a triangle having an apex angle of 90 degrees, and the bottom of the groove is also a triangle of 90 degrees without flat part. In other words, the groove has a width of 50 μm and a depth of about 25 μm. The groove is endless without joints in the circumferential direction of the roller. Thus, a lenticular lens (prism sheet) having a triangle cross section can be formed on the sheet W by the emboss roller 83. The surface of the roller is plated with nickel after making the groove.

A die coater with an extrusion type application head 82C was used as an application device 82.

A solution having a composition described in the table of FIG. 23 was used as a coating solution F (resin solution). The amount of the coating solution F fed to the coating head 82C was controlled by a feeder 82B so that the coating solution F (resin) has a film thickness of 20 μm in a wet state after removing an organic solvent by drying.

A hot air circulating drier was used as a drying device 89. The temperature of the hot air was 100° C.

A roller having a diameter of 200 mm and on which a layer of silicon rubber having a rubber hardness of 90 is formed was used as a nip roller 84. The nip pressure (effective nip pressure) for pressing the sheet W with the emboss roller 83 and the nip roller 84 was 0.5 Pa.

A metal halide lamp was used as a device for curing resin 85 and irradiation was performed at a dose of 1000 mJ/cm².

A prism sheet having an irregularity pattern was prepared by the above process.

### [Preparation of First Diffusion Sheet 12]

A first Fusion sheet 12 (lower diffusion sheet) was prepared by forming an undercoat layer, a backcoat layer and a light diffusion layer in that order by the following method.

Undercoat Layer

A solution A having the following composition which is a coating solution for an undercoat layer was applied to one surface of a polyethylene terephthalate film (support) having a thickness of 100 μm with a wire bar (wire bar size: #10). The solution was dried at 120° C. for 2 minutes to give an undercoat layer having a film thickness of 1.5 μm.

(Coating solution for undercoat layer)

| | |
|---|---|
| methanol | 4165 g |
| JURYMER SP-50T | 1495 g |
| (available from NIHON JUNYAKU Co., Ltd.) | |
| cyclohexanone | 339 g |
| JURYMER MB-1X | 1.85 g |
| (available from NIHON JUNYAKU Co., Ltd.) | |
| (organic particles: cross linked polymethyl | |
| methacrylate, ultrafine spherical | |
| particles having a weight average | |
| particle size of 6.2 μm) | |

Backcoat Layer

A solution B having the following composition which is a coating solution for a backcoat layer was applied to a surface of the support opposite from where the undercoat layer was applied with a wire bar (wire size: #10). The solution was dried at 120° C. for 2 minutes to give a backcoat layer having a film thickness of 2.0 μm.

(Coating solution for backcoat layer)

| | |
|---|---|
| methanol | 4171 g |
| JURYMER SP-65T | 1487 g |
| (available from NIHON JUNYAKU Co., Ltd.) | |
| cyclohexanone | 340 g |
| JURYMER MB-1X | 2.68 g |
| (available from NIHON JUNYAKU Co., Ltd.) | |
| (organic particles: crosslinked polymethyl | |
| methacrylate, ultrafine spherical particles | |
| having a weight average particle size of 6.2 μm) | |

Light Diffusion Layer

A solution C having the following composition which is a coating solution for a light diffusion layer was applied to the undercoat layer side of the support prepared above with a wire bar (wire size: #22). The solution was dried at 120° C. for 2 minutes to give a light diffusion layer. As described later, a light diffusion layer was prepared by applying the solution C immediately after preparation of the solution or applying the solution C after allowing the solution to stand for two hours after preparation.

(Coating solution for light diffusion layer)

| | |
|---|---|
| cyclohexanone | 20.84 g |
| DISPARLON PFA-230, solid concentration 20% by mass | 0.74 g |
| (particle anti-settling agent: fatty acid amide available from | |
| Kusumoto Chemicals, Ltd.) | |
| 20% by mass acrylic resin (DIANAL BR-117 available from | 17.85 g |
| Mitsubishi Rayon Co., Ltd.) solution in methyl ethyl ketone | |
| JURYMER MB-20X (available from NIHON JUNYAKU Co., | 11.29 g |
| Ltd.) (organic particles: crosslinked polymethyl | |
| methacrylate, ultrafine spherical | |
| particles having a weight average particle size of 18 μm) | |
| F780F (available from Dainippon Ink &Chemicals | 0.03 g |
| Incorporated) (30% by mass methyl ethyl ketone solution) | |

### [Preparation of Second Diffusion Sheet 18]

A second diffusion sheet 18 (upper diffusion sheet) was prepared under the same condition and the same flow as in the above-described first diffusion sheet 12 except that the amount added of JURYMER MB-20X in the light diffusion layer of the first diffusion sheet 12 is changed to 1.13 g from 11.29 g.

### [Preparation of Optical Sheet for Display 10]

### Example

An optical sheet for a display 10 (a module of optical sheet) in which the first diffusion sheet 12, the first prism sheet 14, the second prism sheet 16 and the second diffusion sheet 18 are stacked from the bottom, which is shown in FIG. 1 previously described, was prepared using the above sheets.

The production line 11 for an optical sheet for a display (the first process) shown in FIG. 14 previously described was used as a production apparatus. A carbon dioxide gas laser irradiation apparatus was used as the laser irradiation apparatus including the laser head 24. In the apparatus, the wavelength was set at 10 μm, the output was set at 25 W and the frequency was set at 50 kHz.

A process in which the four sides of a laminate was cut out and simultaneously joined by laser irradiation was employed as the process for preparing an optical sheet for a display 10.

The method for producing an optical sheet for a display of the present invention has been described in detail above, but the present invention is not limited to the above examples. Any improvement or modification may be made without departing from the scope of the present invention.

### [Preparation of Optical Sheet for Display]

### Comparative Example

An optical sheet for a display was prepared by a process in which the above sheets (the first diffusion sheet 12, the first prism sheet 14, the second prism sheet 16 and the second diffusion sheet 18) were individually cut into a product size and then the sheets were stacked and joined in that order one by one.

### [Evaluation of Optical Sheet for Display]

100 sets each of the optical sheet for a display in Example and Comparative Example were incorporated into liquid crystal devices and the presence of scratch defect was evaluated. Devices in which a bright line caused by a scratch was visually observed were marked NG.

Of the 100 sets of the Example, only 1 set was marked NG. In contrast, of the 100 sets of the Comparative Example, 24 sets were marked NG. The result of the comparison shows that scratch defect can be remarkably reduced in the Example of the present invention.

1. An equipment for producing an optical sheet for a display, comprising:
a joining device which joins two or more optical sheets at one or more parts;
a cutting device which cuts the optical sheets joined by the joining device or periphery of optical sheets not joined by the joining device into a product size;
a packaging device which stacks and packages the optical sheets joined by the joining device; and
a control device which variably sets the product size and the order of the joining step by the joining device, the cutting step by the cutting device and the packaging step by the packaging device.

2. The equipment for producing an optical sheet for a display according to claim 1, further comprising,
a carrying device which draws the optical sheets joined by the joining device from the joining device and carries the optical sheet to the cutting device or the packaging device in accordance with an instruction from the control device, or draws the optical sheet cut by the cutting device from the cutting device and carries the optical sheet to the joining device or the packaging device in accordance with an instruction from the control device, wherein
the control device notifies the carrying device of a carrying destination, thereby variably setting the order of the joining step, the cutting step and the packaging step.

3. The equipment for producing an optical sheet for a display according to claim 1, wherein
the joining device, the cutting device and the packaging device are unconnected.

4. The equipment for producing an optical sheet for a display according to claim 1, wherein
the joining device and the cutting device are integrated, enabling the joining step and the cutting step to be substantially simultaneously performed.

5. The equipment for producing an optical sheet for a display according to claim 1, wherein
the joining device performs at least one joining of a first joining for joining a light diffusion sheet and a lens sheet, a second joining for joining a light diffusion sheet, a first lens sheet and a second lens sheet, a third joining for joining a first light diffusion sheet, a lens sheet and a second light diffusion sheet and a fourth joining for joining a first light diffusion sheet, a first lens sheet, a second lens sheet and a second light diffusion sheet in accordance with an instruction from the control device.

6. A method for producing an optical sheet for a display, comprising:
a joining step of joining two or more optical sheets at one or more parts;
a cutting step of cutting the optical sheets joined in the joining step or periphery of optical sheets not joined in the joining step into a product size; and
a packaging step comprising stacking and packaging the optical sheets joined in the joining step, wherein
the product size and the order of the joining step, the cutting step and the packaging step are variably set.

7. The method for producing an optical sheet for a display according to claim 6, wherein
the method is performed in the order of the joining step comprising stacking a first optical sheet and a second optical sheet and joining them at one or more parts, the cutting step of cutting periphery of a laminate of the optical sheets obtained by joining in the joining step into a product size and the packaging step comprising stacking and packaging the laminate of optical sheets.

8. The method for producing an optical sheet for a display according to claim 6, wherein
the method is performed in the order of a first cutting step of cutting periphery of a first optical sheet into a first product size and cutting periphery of a second optical sheet into the first product size, the joining step comprising stacking the first optical sheet and the second optical sheet cut in the cutting step and joining them at one or more parts, a second cutting step of cutting periphery of a laminate of the optical sheets obtained by joining in the joining step into a second product size smaller than the first product size and the packaging step comprising stacking and packaging the laminate of optical sheets.

9. The method for producing an optical sheet for a display according to claim 6, wherein
the method is performed in the order of the joining step and the cutting step comprising stacking a first optical sheet and a second optical sheet and joining them at one or more parts, and substantially simultaneously therewith, cutting periphery of a laminate of the first optical sheet and the second optical sheet into a product size, and the packaging step comprising stacking and packaging the laminate of optical sheets.

10. The method for producing an optical sheet for a display according to claim 6, wherein
the method is performed in the order of the cutting step of cutting periphery of a first optical sheet into a product size and cutting periphery of a second optical sheet into a product size, the joining step comprising stacking the first optical sheet and the second optical sheet cut in the cutting step and joining them at one or more parts and the packaging step comprising stacking and packaging a laminate of the optical sheets obtained by joining in the joining step.

11. A method for producing an optical sheet for a display, comprising:
a stacking step of stacking at least one diffusion sheet and at least one lens sheet which have a plane size larger than a product size, thereby preparing a laminate;
a punching step of punching the laminate into a product size, thereby preparing a punched body; and
a joining step of joining the diffusion sheet and the lens sheet at one or more parts corresponding to periphery of the punched body,
wherein a punching blade of a punching die used in the punching step has a blade tip angle of 30° to 60°, a blade thickness of 0.7 mm to 0.9 mm and a blade tip hardness of 45 Hs to 80 Hs in Shore hardness.
